(19) United States
(12) Patent Application Publication
(10) Pub. No.: US 2015/0262182 A1
(43) Pub. Date: Sep. 17, 2015

(54) SYSTEMS AND METHODS FOR PROVIDING POPULATED TRANSACTION INTERFACES BASED ON CONTEXTUAL TRIGGERS

(71) Applicant: The Toronto-Dominion Bank, Mississauga (CA)

(72) Inventors: Steve GERVAIS, Mississauga (CA); Eric KAISER, Mississauga (CA); Peter HORVATH, Mississauga (CA); Andrew CHAK, Mississauga (CA); Christianne MORETTI, Mississauga (CA); Lauren VAN HEERDEN, Bedford, NH (US); Orin DEL VECCHIO, Richmond Hill (CA); Gunalan NADARAJAH, Milton (CA); Tommy PHUNG, Maple (CA)

(73) Assignee: The Toronto-Dominion Bank

(21) Appl. No.: 14/656,528

(22) Filed: Mar. 12, 2015

Related U.S. Application Data
(60) Provisional application No. 61/951,795, filed on Mar. 12, 2014.

(51) Int. Cl. G06Q 20/40; G06Q 20/10

(52) U.S. Cl. CPC G06Q 20/405; G06Q 20/10

(57) ABSTRACT

The disclosed embodiments include methods and systems that automatically populate interfaces facilitating electronic transactions. In one embodiment, a system may identify a contextual event triggering an account transfer transaction. The system may also determine a first account associated with a first user based on the contextual event, and determine a second account based on the contextual event and a set of rules associated with the first user. The system may generate, based on the detected event and the set of rules, first information used to provide prefilled content identifying the first account as a source account and the determined second account as a destination account. The system may also generate, in response to an authorization, second information used to provide second content including a notification that a transfer of funds from the first account to the second account has occurred.

### CROSS-REFERENCE TO RELATED APPLICATIONS

This application claims the benefit of priority to U.S. Provisional Patent Application No. 61/951,795, filed Mar. 12, 2014, the entire disclosure of which is expressly incorporated herein by reference to its entirety.

### BACKGROUND

1. Technical Field

The disclosed embodiments generally relate to systems and methods for account transactions, and more particularly, and without limitation, to systems and methods for automatically populating interfaces for electronic fund transfer transactions in response to contextual trigger events.

2. Background

Today, financial transactions are routinely conducted electronically. Wireless communications devices, such as laptops, netbooks, cellular phones, smart phones, personal digital assistants, tablets, etc., facilitate the increased use of electronic financial transactions for common transactions such as account transfers and bill payment. Even with wireless communications devices, individuals must still conduct numerous, sometimes mundane, transactions, which may be time consuming and easy to overlook. Aspects of the disclosed embodiments address these and other concerns regarding electronic financial transactions.

### SUMMARY

The disclosed embodiments include methods and system for providing automated transaction assistance. In one embodiment, a system may include a first memory storing instructions and one or more processors configured to execute the instructions to perform operations. In one embodiment, the operations may include identifying a contextual event that triggers an account transfer transaction. In some aspects, the identification may be based on contextual data associated with a first user. The operations may also include identifying (I) a first account of a first user based on the contextual triggering event and (ii) a second account of the first user based on the contextual triggering event and a set of rules associated with the first user. The operations may further include obtaining online session data associated with the first user. In some aspects, the online session data may correspond to at least one prior online session of the first user, and the online session data may include account information associated with at least one of the first or second accounts. In addition, the operations may include determining a first amount of funds to transfer from the first account to the second account based on at least a portion of the online session data, and generating, based on the triggering event and the set of rules, first information for presentation to the first user in an interface. In some aspects, the first information may include prefilled content identifying at least one of the first accounts as a first source account in the interface, the second account as a destination account in the interface, or the first transfer amount in an amount field of the interface. The operations may also include generating, in response to an authorization, second information for presentation to the first user. In some aspects, the second information may include a notification of an occurrence of a transfer of funds from the first account to the second account.

The disclosed embodiments may also include a computer-implemented method that identifies, by at least one processor, a contextual event that triggers an account transfer transaction. In some aspects, the identification may be based on contextual data associated with a first user. The method also includes, by the at least one processor, identifying (I) a first account of a first user based on the triggering event and (ii) a second account of the first user based on the triggering event and a set of rules associated with the first user. The method further includes obtaining, by the at least one processor, online session data associated with the first user. In some aspects, the online session data may correspond to at least one prior online session of the first user, and the online session data includes account information associated with at least one of the first or second accounts. In addition, the method includes determining, by the at least one processor, a first amount of funds to transfer from the first account to the second account based on at least a portion of the online session data, and generating, by the at least one processor, and based on the triggering event and the set of rules, first information for presentation to the first user in an interface. In some aspects, the first information may include prefilled content identifying at least one of the first accounts as a first source account in the interface, the second account as a destination account in the interface, or the first transfer amount in an amount field of the interface. In response to an authorization, the method also includes generating, by the at least one processor, second information for presentation to the first user. In some aspects, the second information including a notification of an occurrence of a transfer of funds from the first account to the second account.

In other embodiments, a tangible, non-transitory computer-readable medium stores instructions that, when executed by at least one processor, cause the at least one processor to perform a method that identifies a contextual event that triggers an account transfer transaction. In some aspects, the identification may be based on contextual data associated with a first user. The method also includes identifying (i) a first account of a first user based on the contextual triggering event and (ii) a second account of the first user based on the contextual triggering event and a set of rules associated with the first user. The method further includes obtaining online session data associated with the first user. In some aspects, the online session data may correspond to at least one prior online session of the first user, and the online session data includes account information associated with at least one of the first or second accounts. In addition, the method includes determining a first amount of funds to transfer from the first account to the second account based on at least a portion of the online session data, and generating, by the at least one processor, and based on the triggering event and the set of rules, first information for presentation to the first user in an interface. In some aspects, the first information may include prefilled content identifying at least one of the first accounts as a first source account in the interface, the second account as a destination account in the interface, or the first transfer amount in an amount field of the interface. In response to an authorization, the method also includes generating second information for presentation to the first user. In some aspects, the second information including a notification of an occurrence of a transfer of funds from the first account to the second account.

In certain example, exemplary objects and advantages of the disclosed embodiments may be set forth in part in the description that follows, and in part will be obvious from the description, or may be learned by practice of the disclosed embodiments. It is to be understood that both the foregoing general description and the following detailed description are exemplary and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 depicts an exemplary computing environment consistent with disclosed embodiments.

FIG. 2 depicts an exemplary computing system consistent with the disclosed embodiments.

FIGS. 3A and 3B depict flowcharts of exemplary configuration processes for providing transaction assistance consistent with disclosed embodiments.

FIG. 3C depicts an exemplary arrangement of transaction assistance configuration rules consistent with disclosed embodiments.

FIG. 4 depicts another flowchart of an exemplary process for providing transaction assistance consistent with disclosed embodiments.

FIG. 5 depicts a diagram of an exemplary user interface providing transaction assistance consistent with disclosed embodiments.

FIGS. 6A, 6B, 7, 8A, and 8B are diagrams of exemplary user interfaces consistent with disclosed embodiments.

### DESCRIPTION OF THE EMBODIMENTS

Reference will now be made in detail to disclosed embodiments, examples of which are illustrated in the accompanying drawings. Wherever possible, the same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise.

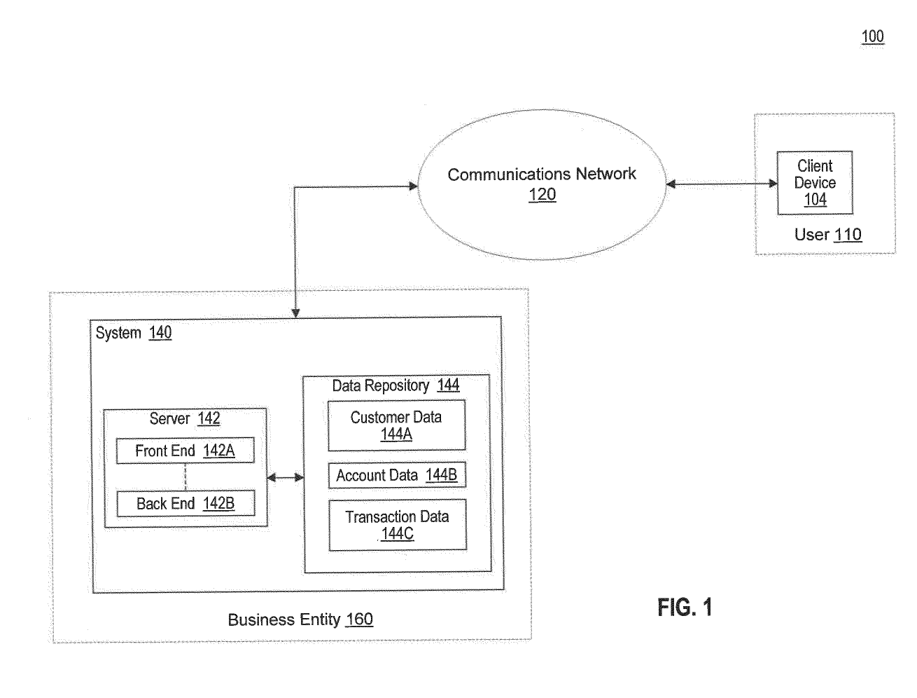

FIG. 1 illustrates an exemplary computing environment 100 consistent with certain disclosed embodiments. In one aspect, computing environment 100 may include a client device 104, a system 140, and a communications network 120 connecting one or more of the components of environment 100.

In one embodiment, system 140 may be one or more computer systems configured to process and store information and execute software instructions to perform one or more processes consistent with the disclosed embodiments. In certain exemplary embodiments, although not required, system 140 may be associated with one or more business entities, such as business entity 160. In certain embodiments, business entity 160 may be any type of business entity. For example, system 140 may be a system associated with a commercial bank, an investment bank, a provider of a payment instruments, a provider of one or more accounts, etc. In some embodiments, an account may be a check, savings, credit, debit, brokerage, wealth, a reward or loyalty account, or any type of financial service account. In some aspects, a payment instrument may include, but is not limited to, a personal or corporate credit card, a debit card, a prepaid credit or debit card, or check instruments.

While certain aspects of the disclosed embodiments are described in connection with business entity 160 as a financial institution that provides financial service accounts to user 110 (and other users) and processes financial transactions associated with those financial service accounts, the disclosed embodiments are not so limited. In other embodiments, system 140 may be associated with a business entity 160 that provides accounts for users for other types of transactions, such as hotel guest accounts, passport or travel identification accounts, location access identification accounts (e.g., employment, government identification accounts, educational institution related accounts (e.g., student identification, meal cards, etc.), and the like.

In certain embodiments, system 140 may include one or more servers 142 and one or more data storages, such as data repository 144. Server 142 may be, for example, a computing system that processes, among other things, transactions, and thus for exemplary purposes only. A transaction may include financial transactions (e.g., purchase transactions, banking transactions, etc.), or other forms of transactions (e.g., access to a location, check out transactions of material, products, goods, etc., such as library transactions, etc.). Transactions may also include account management tasks, such as funds transfers, bill payments, providing access to account information (e.g., balance checking, bill payment checking, etc.), and other forms of tasks associated with managing accounts provided by business entity 160 and system 140.

In one embodiment, server 142 may include a front end 142A, and a back end 142B in communication with front end 142A, although the configuration of server 142 is not limited to such configurations. In one example, front end 142A and back end 142B of server 142 may be incorporated into a single computer, a single server, or any additional or alternate computing device apparent to one or skill in the art. In other embodiments, front end 142A and backend 142B may be distributed computing devices. Further, in one embodiment, front end 142A may be one or more software programs, such as a software application (e.g., a web service) executed by one or more processors included in server 142. Similarly, backend 142B may be one or more software programs executed by one or more processors included in server 142. Server 142 is not limited to such configurations. In additional embodiments, front end 142A software can be executed by a server or computing system separate from a server or computing system that executes back end 142B.

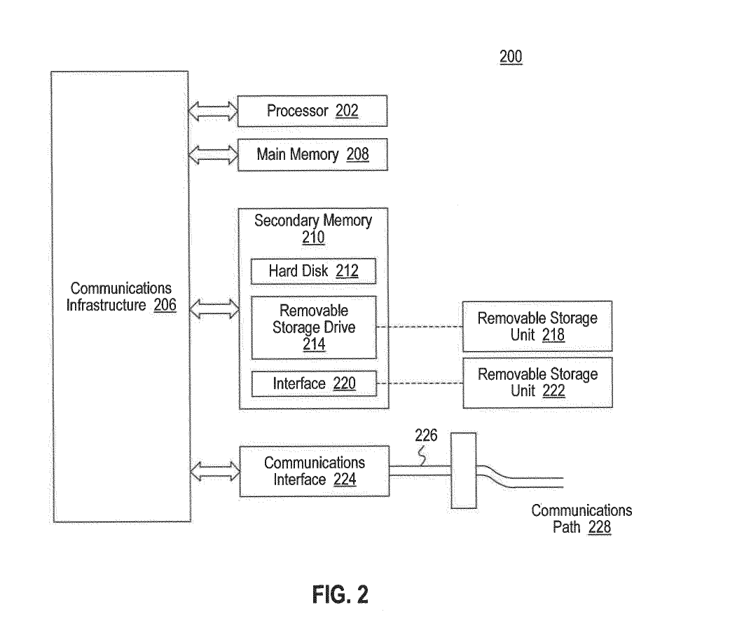

Server 142 may be configured to execute software instructions to perform one or more processes consistent with the disclosed embodiments. In one embodiment, client device 104 may exchange information and parameters facilitating execution of one or more transactions associated with system 140. In one embodiment, where business entity 160 is a financial institution that provides financial service accounts and system 140 is configured to perform financial service account transaction processes, transactions may include, but are not limited to, a purchase or sale of goods or services, a transfer of funds between financial accounts (e.g., checking, savings, investment, etc.), a payment of a bill, a purchase or sale of a financial instrument or security, a deposit or withdrawal of funds, or an application for credit. Server 142 may be implemented with one or more processors or computer-based systems, such as for example, a computer-system 200 of FIG. 2).

Data repository 144 may be one or more data storages configured to store information consistent with the disclosed embodiments. In one aspect, data repository 144 may include customer data 144A, account data 144B, and transaction data 1440. In one aspect, customer data 144A may include one or more data records uniquely identifying one or more users 110 of business entity 160 associated with system 140. By way of example, a customer of a financial institution (e.g., business entity 160) may access a web page associated with system 140 (e.g., through a web server executed by front end 142A), and subsequently register for online banking services and provide data. The data may be linked to the customer and stored within customer data 144A.

In certain aspects, customer data 144A may include personal information associated with a user 110 (e.g., a name, home address, or date of birth), demographic information (e.g., educational level, income level), government-issued identifiers (e.g., driver's license numbers or Social Security numbers), employment information (e.g., employer name or address), and/or contact information (e.g., e-mail addresses, home numbers, work numbers, or mobile numbers). Other types of customer information may be stored and used by the disclosed embodiments.

Customer data 144A may include client device identification information identifying one or more client devices 104 registered to user 110. In one embodiment, the user may provide the client device identification information (e.g., a mobile telephone number provided by the user when registering for online banking services). Alternatively, server 142 may be configured to execute processes that automatically collect client device identification information (e.g., collecting an Internet Protocol (IP) address associated with the customer's smartphone),

In an embodiment, customer data 144A may include geographic position data associated with user 110 and/or at least one of client devices 104 registered to user 110. For instance, the geographic position data may identify a current geographic position of user 110 and/or client devices 104, and additionally or alternatively, one or more prior geographic positions of user 110 and/or client devices 104. Geographic position data consistent with the disclosed embodiments may include, but is not limited to, a latitude, longitude, and/or altitude of a current or prior geographic position, additional geospatial coordinates or position information (e.g., a Where On Earth Identified (WOEID)), a geographic region associated with a current or prior geographic position, and/or a postal code associated with a current or prior geographic position.

In certain aspects, system 140 may obtain a portion of the geographic position data from client device 104 across communications network 120. By way of example, client device 104 may include a global position system (e.g., a GPS) that tracks a current geographic position of client device 104, and client device 104 may transmit geographic position data indicative of the current geographic position of client device 104 to system 140 across communication network 120. For instance, client device 104 may append the geographic position data to data transmitted to system 140 in response to a completed transaction, and/or a required update to system 140. In other instances, client device 104 may transmit the geographic position data to a third-party system (e.g., a mobile telecommunications provider), and system 140 may obtain portions of the geographic position data from the third-party system across network 140 through an appropriate application programming interface (API). Upon receipt of the geographic position data from client device 104 and/or the third party system, system 140 may be configured to format and store the received positional information within database 144 (e.g., as portions of customer data 144A).

In certain aspects, account data 144B may include information identifying one or more accounts of customers of a financial institution (e.g., business entity 160) associated with system 140. In one embodiment, account identification information may include financial service account information. For example, such service account information may include a checking account, a savings account, a revolving credit line, an account linked to a credit or debit card, a brokerage account, a wealth account, an investment account, and any additional or alternate account provided or supported by the issuing bank. In other embodiments, account data 144B may include information identifying investment portfolios held by one or more customers of the financial institution (e.g., positions in one or more securities held by the customers). Information within account data 144B may also identify, for a single customer, one or more accounts associated with the customer and account data corresponding to the accounts (e.g., account, expiration date information, and/or card security codes, account balance information, and/or credit limit information).

In other aspects, account data 144B may include account information associated with nonfinancial service accounts, such as membership accounts for certain services or activities (e.g., gym membership, prescription drug information, library card, employment identification, student account information, etc.).

Transaction data 144C may include information identifying one or more transactions involving one or more customers or accounts of business entity 160 associated with system 140. In one embodiment, such transactions may include, but are not limited to, purchase transactions (e.g., purchases of goods and/or services from electronic or physical retailers), financial service transactions (e.g., fund transfers), bill payment transactions (e.g., electronic bill payment transactions), financial instrument or security transactions (e.g., purchases of securities), deposits or withdrawals of funds, or applications for credit from the financial institution or other entity.

For example, system 140 may be configured to execute software instructions that perform processes that provide an online financial service portal enabling a user 110 (e.g., “customer”) to perform account management transactions. In one embodiment, the service portal may enable the customer to execute an electronic funds transfer (EFT) transaction that transfers funds between one or more source customer accounts to one or more destination accounts (e.g., accounts associated with user 110 and/or other users), to schedule automatic bill payment services (e.g., select an amount and periodic payment date for making payments to an identified payee from the customer's selected financial account), to purchase goods or services, and other known types of online financial service processes. For instance, server 142 may generate a data record within transaction data 144C corresponding to the particular service the customer initiates, such as an initiated transfer of funds, and may populate the data record with information associated with the initiated transaction.

As an example, transaction information for an EFT transaction may include, but is not limited to, a unique identifier associated with the fund transfer transaction, a timestamp of the transaction, and transaction parameter information (e.g., one or more source accounts, one or more destination or target accounts, a transaction date, and an amount of transfer). For another example, transaction information associated with the purchase or sale of a good from a physical retailer may include, but is not limited to, the location of the retailer, the type of retailer, the type of goods purchased, and the amount of the purchase.

Client device 104 may be one or more client devices. In certain embodiments, client device 104 may be associated with one or more users 110. System 100 may include multiple client devices 104, each associated with a separate user 110 or with one or more users 110. In certain embodiments, user 110 may operate client device 104 such that client device 104 performs one or more processes consistent with the disclosed embodiments. For example, user 110 may use client device 104 to perform a transaction involving one or more accounts associated with user 110 and/or other users and provided, maintained, managed, and/or processed by system 140. In certain aspects, client device 104 can include, but is not limited to, a personal computer, a laptop computer, a tablet computer, a notebook computer, a hand-held computer, a personal digital assistant, a portable navigation device, a mobile phone, a wearable device, an embedded device, a smart phone, a set top box, third party portals, an automated teller machine (ATM), an optical disk player (e.g., a DVD player), a digital video recorder (DVR), and any additional or alternate computing device, and may be operable to transmit and receive data across network 120. Client device 104 may be implemented with one or more processors or computer-based systems, such as for example, computer-system 200 of FIG. 2.

Further, although computing environment 100 is illustrated in FIG. 1 with one client device 104, that the disclosed embodiments may include a plurality of client devices 104, each associated with one or more users 110 (e.g., a first client device operated by a first user and a second client device operated by a second user). Similarly, although computing environment 100 is illustrated in FIG. 1 with a single system 140 and user 110, system environment 100 may include any number of additional systems 140, client devices 104, and/or users 110.

Communications network 120 may include one or more communication networks or medium of digital data communication. Examples of communication network 120 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet. Consistent with embodiments of the present disclosure, communications network 120 may include the Internet and any publicly accessible network or networks interconnected via one or more communication protocols, including, but not limited to, hypertext transfer protocol (HTTP) and transmission control protocol/internet protocol (TCP/IP). Communications protocols consistent with the disclosed embodiments also include protocols facilitating data transfer using radio frequency identification (RFID) communications and/or NFC. Moreover, communications network 120 may also include one or more mobile device networks, such as a GSM network or a PCS network, allowing client device 104 to send and receive data via applicable communications protocols, including those described herein.

FIG. 2 illustrates an exemplary computer system 200 with which embodiments consistent with the present disclosure may be implemented. In certain embodiments, computer system 200 may reflect computer systems associated with system 140, server 142, and/or client device 104. In certain embodiments, computer system 200 may include one or more processors 202. Processor 202 may be connected to a communication infrastructure 206, such as a bus or communications network, e.g., a communications network 120 depicted in FIG. 1.

Computer system 200 may also include a main memory 208, for example, random access memory (RAM), and may include a secondary memory 210. Memory 208 may represent a tangible and non-transitory computer-readable medium having stored therein computer programs, sets of instructions, code, or data to be executed by processor 202. Secondary memory 210 may include, for example, a hard disk drive 212, and/or a removable storage drive 214, representing a magnetic tape drive, flash memory, an optical disk drive, CD/DVD drive, etc. The removable storage drive 214 may read from and/or write to a removable storage unit 218 in a well-known manner. Removable storage unit 218 may represent a magnetic tape, optical disk, or other storage medium that is read by and written to by removable storage drive 214. Removable storage unit 218 may represent a tangible and non-transitory computer-readable medium having stored therein computer programs, sets of instructions, code, or data to be executed by processor 202.

In alternate embodiments, secondary memory 210 may include other means for allowing computer programs or other program instructions to be loaded into computer system 200. Such means may include, for example, a removable storage unit 222 and an interface 220. An example of such means may include a removable memory chip (e.g., EPROM, RAM, ROM, DRAM, EEPROM, flash memory devices, or other volatile or non-volatile memory devices) and associated socket, or other removable storage units 222 and interfaces 220, which allow instructions and data to be transferred from the removable storage unit 222 to computer system 200.

Computer system 200 may also include one or more communications interfaces, such as communications interface 224. Communications interface 224 allows software and data to be transferred between computer system 200 and external devices. Examples of communications interface 224 may include a modem, a network interface (e.g., an Ethernet card), a communications port, a PCMCIA slot and card, etc. Communications interface 224 may transfer software and data in the form of signals 226, which may be electronic, electromagnetic, optical or other signals capable of being received by communications interface 224. These signals 226 may be provided to communications interface 224 via a communications path (i.e., channel 228). Channel 228 carries signals 226 and may be implemented using wire, cable, fiber optics, RF link, and/or other communications channels. In a disclosed embodiment, signals 226 comprise data packets sent to processor 202. Information representing processed packets can also be sent in the form of signals 226 from processor 202 through communications path 228.

In certain embodiments in connection with FIG. 2, the terms “storage device” and “storage medium” may refer to tangible memory devices including, but not limited to, main memory 208, secondary memory 210, a hard disk installed in hard disk drive 212, and removable storage units 218 and 222. Further, a “computer-readable medium” may refer to tangible and non-transitory memory devices including, but not limited to, a hard disk installed in hard disk drive 212, any combination of main memory 208 and secondary memory 210, and removable storage units 218 and 222, which may respectively provide computer programs and/or sets of instructions to processor 202 of computer system 200. Such computer programs and sets of instructions can be stored within one or more computer-readable media. Additionally or alternatively, computer programs and sets of instructions may also be received via communications interface 224 and stored on the one or more computer-readable media.

Such computer programs and instructions, when executed by processor 202, enable processor 202 to perform one or more processes consistent with the disclosed embodiments. Examples of program instructions include, for example, machine code, such as code produced by a compiler, and files containing a high-level code that can be executed by processor 202 using an interpreter.

Furthermore, the computer-implemented methods described herein can be implemented on a single processor of a computer system, such as processor 202 of system 200. In additional embodiments, however, these computer-implemented methods may be implemented using one or more processors within a single computer system, and additionally or alternatively, these computer-implemented methods may be implemented on one or more processors within separate computer systems linked via a network.

The disclosed embodiments include methods and systems that may be configured to provide transaction assistance. In certain aspects, the disclosed embodiments may allow a user 110 to configure settings for performing transaction assistance based on a set of rules (e.g., one or more rules) that may control how certain assistance is provided. For example, the disclosed embodiments may perform operations that automatically prefill information that is displayed as content on one or more interfaces that may be displayed by client device 104. The prefilled information may include source or destination account information, transfer amount data reflecting an amount of funds to transfer from the source account(s) to the destination account(s). In certain aspects, the disclosed embodiments may perform processes that automatically determine one or more source accounts, one or more destination accounts, and one or more transfer amounts, the distribution of the transfer amount(s) among multiple source and/or destination accounts, etc. In certain aspects, the disclosed embodiments may make such determinations based on one of more rules configured by system 140 and/or through input from user 110. In one embodiment, the disclosed embodiments may allow user 110 to provide this input through a configuration process provided by system 140 and/or client device 104.

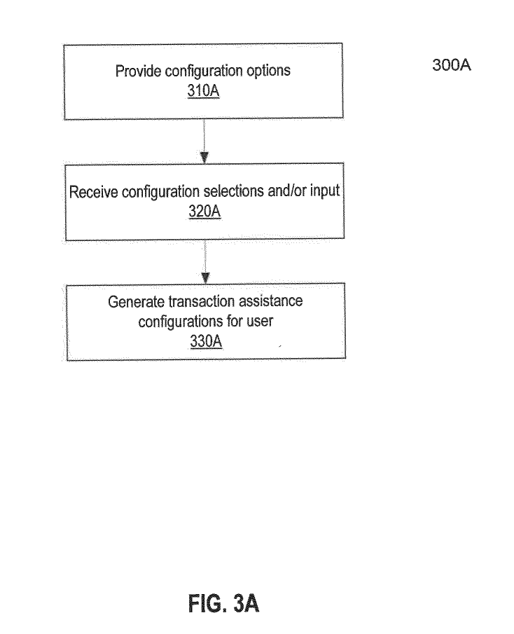

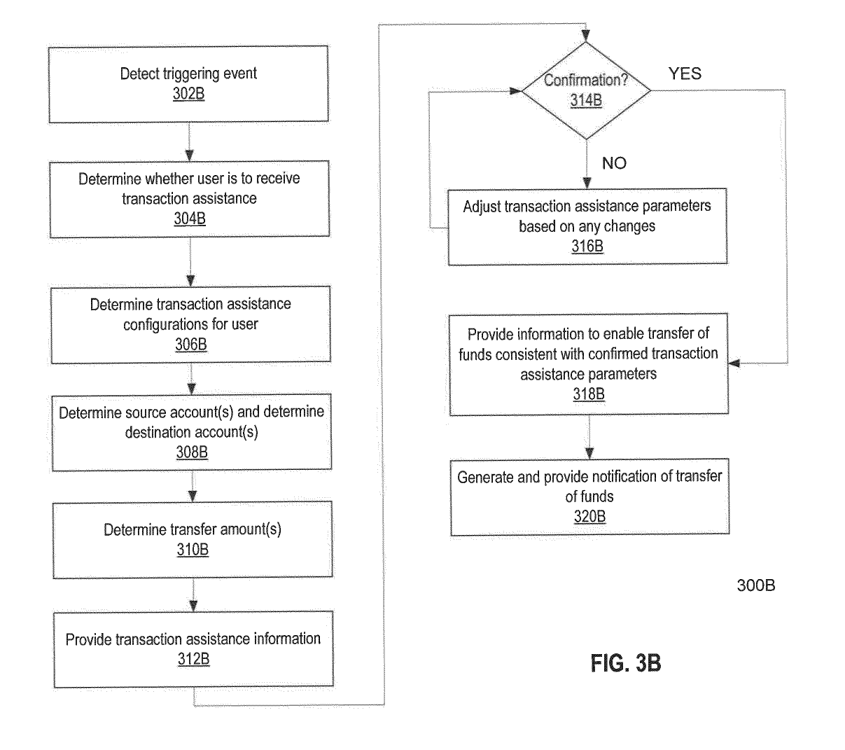

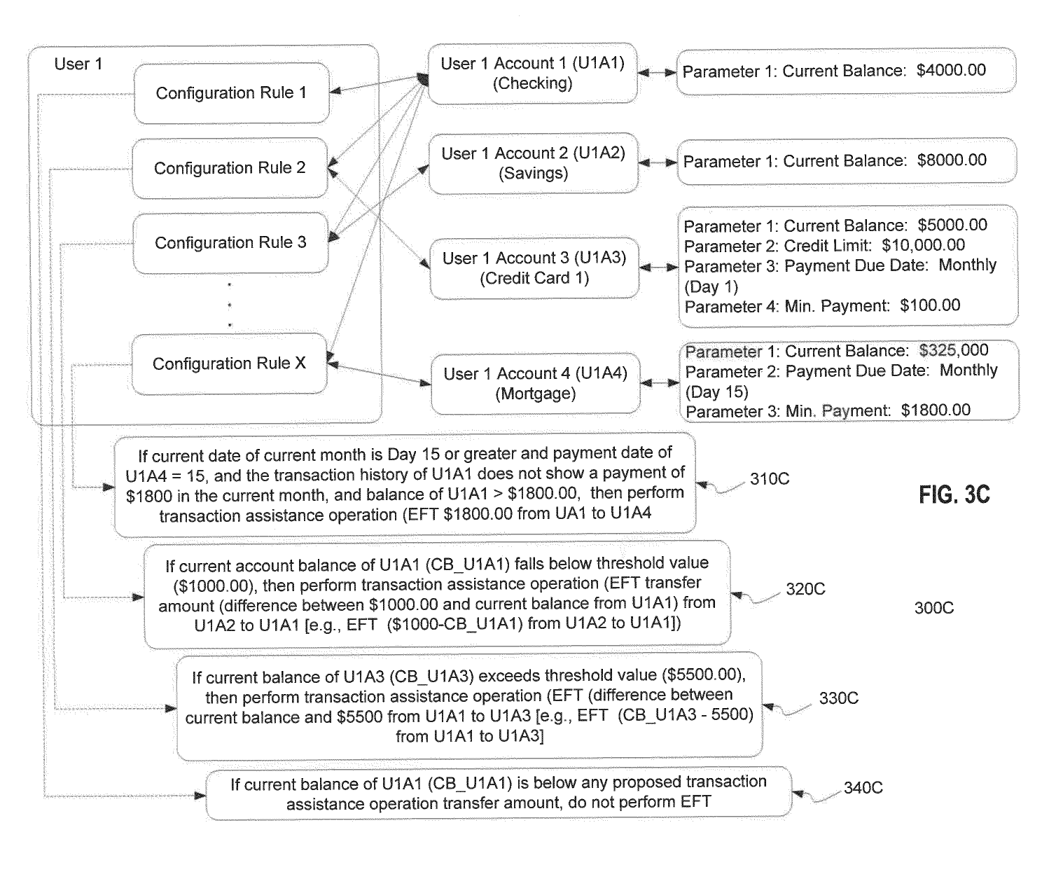

FIG. 3A shows a flowchart of an exemplary configuration process 300A consistent with disclosed embodiments. In one embodiment, process 300A may be performed by system 140. In one aspect, system 140 may generate and provide one or more configuration options that may be used by user 110 to configure one or more transaction assistance operations provided by the disclosed embodiments (step 310A). For example, server 140 may provide an online portal, such as websites, etc., that is accessible by user 110 over communication network 120. System 140 may present one or more configuration options in interface(s) that enable a user, through client device 104, to input information or select one or more options (e.g., radio buttons, menu items, etc.) associated with configuring how the disclosed embodiments may provide one or more transaction assistance operations. In one embodiment, system 140 may request that user 110 select one or more accounts that may be linked to the transaction assistance operations (e.g., checking, savings, credit, creditor accounts, etc.). System 140 may also request that user 110 configure one or more rules and associated threshold value(s) that the disclosed embodiments may use to perform one or more operations consistent with the disclosed embodiments. As an example, system 140 may generate and provide option(s) that request user 110 to identify a threshold value associated with a first account (or one or more account parameters associated with the first account) that initiates a triggering event to perform a transfer assistance process. For instance, the disclosed embodiments may allow user 110 to configure a rule (or system 140 may be programmed to provide a rule) that causes a triggering event when a balance of the first account falls below a determined threshold value (e.g., 200.00).

The disclosed embodiments may allow the user to select the first account as a destination account and may allow the user to identify a second account as a source account that may be used to transfer funds from to the first account. In other embodiments, the disclosed embodiments may allow the user to identify one or more accounts as source accounts and/or one or more accounts as destination accounts. Further, in certain aspects, the disclosed embodiments may allow the user to configure one or more rules (or system 140 may be programmed to provide one or more rules) that facilitate a selection of the first and/or second accounts based on a detected currency type. For example, the configured rules may require that the first and/or second accounts be denominated in the detected currency type, and additionally or alternatively, be held at a financial institution that performs transactions denominated in the detected currency type. The disclosed embodiments may perform one or more processes based on detecting a triggering event based on the set of rules configured by the user and/or system 140. The above examples are not limiting to the disclosed embodiments.

User 110 may use client device 104 to provide configuration selections and/or inputs that may be used by system 140 for configuring transaction assistance operations for user 110. System 140 may receive the configuration selections and input (step 320A) and based on that information generate transaction assistance configurations for the user (step 330A). In one embodiment, system 140 may configure one or more rules based on input from the user or default data programmed in system 140 that control how the disclosed embodiments may provide one or more transaction assistance operations. The configurations for the user may include processes that generate triggering events based on low account balance(s), payment due date(s) for one or more accounts (e.g., utility bill account, credit card account, merchant account, mortgage account, car payment account, etc.), and other types of account parameters.

In another embodiment, a triggering event may reflect a user initiated event, such as system 140 receiving a request from user 110, via client device 104, to perform an account transfer. In some embodiments, client device 104 may perform processes that present an icon or similar item on an interface that when selected (e.g., one click, swipe, tap, etc.) causes the disclosed embodiments to automatically perform one or more configured account transfer transactions (e.g., transfer a determined transfer amount from a determined source account to a determined destination account). The account transfer transactions may be configured based on user input during configuration process 300A, one or more programmed settings in system 140, or a combination of both.

FIG. 3B shows a flowchart of an exemplary transaction assistance process 300B consistent with disclosed embodiments. In certain aspects, system 140 may perform one or more operations of process 300B. In other embodiments, client device 104 may perform one or more operations of process 300B. In one example, system 140 (or client device 104) may execute software instructions that perform operations that include detecting a triggering event (step 302B). As mentioned above, a triggering event may be associated with a configured event or a user-initiated event that may be used to initiate one or more operations relating to the transaction assistance operations consistent with the disclosed embodiments. For example, a triggering event may be related to a transaction that occurred involving an account (e.g., user 110 purchases one or more goods from a merchant), a user request to perform a funds transfer (e.g., user 110 access an account management tool in an online portal to perform an EFT, user requesting a funds transfer by selecting an icon or similar item on an interface of client device 104, etc.), a configured event (e.g., a user-specified event such as an account balance falling below a threshold, a default event programmed in system 140 tracking account balances that detects when an account balance falls below a threshold, etc.), and any other type of event that may be configured by system 140 and/or user 110 in accordance with the disclosed embodiments.

System 140 (or client device 104) may determine whether a user associated with the triggering event is to receive transaction assistance (step 304B). For example, the disclosed embodiments may determine whether user 110 has opted to receive transaction assistance through, for example, the configuration process 300A. System 140 may, in one example, perform processes that determine whether user 110 has selected option(s) to receive transaction assistance, set configurations for such assistance, etc. In another embodiment, client device 104 may perform processes that check a setting stored in client device 104 that indicates that user 110 has opted in to receive transaction assistance,

If the user is to receive transaction assistance, system 140 may determine the transaction assistance configurations for the user (step 306B). For instance, system 140 may access stored configuration information that may have been generated and stored during configuration process 300A. Based on the transaction assistance configurations, system 140 may determine one or more source account(s) based on the transaction assistance configurations for the user (step 308B). System 140 may also determine one or more destination account(s) based on the configurations (step 308B). For example, system 140 may analyze the transaction assistance configurations for user 110 to determine a first account that may be identified as a source account for providing funds in a funds transfer. System 140 may also determine a second account as a destination account for receiving funds from the source account. In other embodiments, based on the transaction assistance configurations (e.g., one or more rules, thresholds, etc.), system 140 may determine one or more accounts as a source and/or destination account(s),

In some aspects, system 140 may determine the source and/or destination accounts based on a type of currency associated with the transaction related to the triggering event. By way of example, system 140 may automatically determine the currency type, and may identify a source account and/or a destination account in accordance with rules specified by the transaction assistance configurations. For instance, the rules may specify that the source account and/or the destination account be denominated in the determined currency type, and additionally or alternatively, be held at financial institutions that facilitate transactions denominated in the determined currency type. In certain aspects, system 140 may determine that the transaction is denominated in Canadian dollars, and may identify a source account and/or a destination account denominated in Canadian dollars, or alternatively, held at a Canadian bank. The disclosed embodiments are, however, not limited to transactions denominated in Canadian dollars, and in additional embodiments, the transaction assistance configurations may include rules that specify source and/or destination accounts for transaction denominated in U.S. dollars, Euros, Japanese yen, Chinese renminbi, and any additional or alternate currency appropriate to system 140 and the user,

System 140 may also determine one or more transfer accounts based on the transaction assistance configurations for the user (step 310B). For example, system 140 may execute software instructions that perform operations including determining whether a configuration setting indicates that a transfer amount field to be displayed on client device 104 is be empty (e.g., to allow user to enter in a transfer amount). Alternatively, system 140 may determine a transfer amount associated with the transfer transactions based on one or more configuration settings (e.g., based on a configured rule, system 140 may determine that the transfer amount should be set at $100). In certain embodiments, system 140 may determine a transfer amount as a fixed amount (e.g., $100.00) based on one or more configured settings. For instance, the disclosed embodiments may allow user 110 to configure a transaction assistance rule that identifies a fixed transfer amount (e.g., $100.00) to be transferred between an identified source and an identified destination account in response to one or more identified triggering events (e.g., a user request, a low destination account balance, etc.). In other embodiments, system 140 may determine a transfer amount as a variable amount. For example, system 140 may perform processes that determine the transfer amount based on an analysis of one or more parameters associated with the determined source and/or destination account(s). For instance, system 140 may determine a transfer amount based on a balance of an account. As an example, user 110 may have a credit card account (or other form of account that requires payment(s)). System 140 may determine the transfer amount for the transaction assistance process based on a minimum payment due on the user's credit card account. Alternatively, system 140 may determine a transfer amount based on an outstanding balance of the credit card account.

In other embodiments, system 140 may determine multiple transfer amounts (e.g., two or more transfer amounts). For example, system 140 may be configured to determine two source accounts associated with an account transfer operation (e.g., account 1 and account 2 associated with user 110). In this exemplary embodiment, system 140 may determine a first transfer amount that reflects an amount of funds to transfer from account 1 and a second transfer amount that reflects an amount of funds to transfer from account 2. In other embodiments, system 140 may determine the transfer amount based on a combination of multiple accounts and one or more parameters of one or more accounts. For example, system 140 may be configured to determine a transfer amount as a function of one or more parameters of one or more accounts (e.g., determine a transfer amount as a portion, percentage, etc. (e.g., half the amount, twice, 10%, etc.) of a balance or minimum payment due or other parameter of a destination account(s).

As another example, system 140 may analyze parameters of accounts to determine a transfer amount. For instance, user 110 may be associated with a first account having a balance of $500 and a second account with a balance of $1000. System 140 may, in one example, determine the first account as a source account and the second account as a destination account for a transfer operation. In determining the transfer amount, system 140 may perform processes that assess a configured rule (e.g., user-specified or other) that requires a certain percentage or a minimum balance for the first account remains after an account transfer involving the first account (e.g., first account is to have a minimum a balance of 400.00 after any transfer operation). In such an example, system 140 may determine a $100.00 transfer amount for a transfer operation involving the first and second accounts, where the $100.00 is to be transferred from the first account (e.g., source account) to ensure the configured minimum balance of $400.00 is maintained for the source account after the transfer.

Referring back to FIG. 3B, system 140 may generate transaction assistance information for the user based on the analysis of the user's transaction assistance configurations. System 140 may provide the transaction assistance information (step 312B). For instance, based on the triggering event and transaction assistance configurations for the user, and/or the determined account(s) and transfer amount(s), system 140 may generate information that may be used to provide first content for display. For example, system 140 may generate information that includes in the first content prefilled content that identifies one or more accounts as one or more respective source accounts and one or more accounts as one or more destination accounts. In certain aspects, the first content may also include a transfer amount field that may be associated with a transfer amount reflecting an amount of funds to transfer from the source account(s) to the destination account(s). In certain embodiments, depending on the determinations by system 140 from assessing and analyzing the transaction assistance configurations, account parameters, and triggering event(s) associated with the user, system 140 may prefill the transfer amount field with a determined transfer amount in a manner consistent with the embodiments and examples disclosed above.

In one embodiment, system 140 may provide the transaction assistance information to client device 104. System 140 may provide the information in different formats. For example, in one embodiment, system 140 may generate the information used to display the first content such that system 140 generates an interface that is provided to client device 104. Client device 104 may be configured to receive the interface and display it on a display device of client device 104. In other embodiments, system 140 may provide transaction assistance information to client device 104, which uses the information to generate content that may be used for display. For example, system 140 may generate information that when received and processed by client device 104, generates content for display on a display device of client device 104. The content may include, for example, prefilled content that identifies one or more accounts as one or more respective source accounts and one or more accounts as one or more destination accounts. In certain aspects, the content may also include a transfer amount field that may be associated with a transfer amount reflecting an amount of funds to transfer from the source account(s) to the destination account(s).

In certain embodiments, system 140 may obtain a confirmation that a transfer transaction is to occur (step 314B). For example, server 140 may obtain information over network 120 that indicates that user 110, via client device 104, has authorized and confirmed that a certain transfer transaction is to occur. For instance, client device 104 may display on an interface content that requests confirmation from user 110 that a transfer transaction and set forth in the transaction assistance information, and displayed in an interface, is to occur. The user may authorize the transaction by selecting an input displayed on the interface. Alternatively, system 140 may automatically generate and determine that confirmation of the transaction has occurred depending on how the transaction assistance configuration for the accounts and proposed transfer transaction has been set up. For instance, system 140 may not request confirmation from a user, but instead may determinate automatically based on one or more rules that confirmation of a transfer transaction exists. In one aspect, client device 104 may perform confirmation assessment processes, which may provide results of the confirmation assessment to system 140.

In certain embodiments, if no confirmation is obtained (step 314B; No), system 140 and/or client device 104 may request one or more changes to the one or more transaction assistance parameters (step 316B). For example, system 140 and/or client device 104 may provide requests via one or more interfaces that inquire one or more changes to one or more parameters associated with a transfer transaction that is presented to user 110. For instance, when providing the content in an interface for a user 110, the disclosed embodiments may allow user 110 to adjust one or more source accounts, one or more destination accounts, one or more transfer amounts, one or more time frames for performing a transaction, etc. In response to any changes, system 140 and/or client device 104 may adjust the transaction assistance parameters based on the changes, and the process may continue to step 314B.

On the other hand, if confirmation is obtained (step 314B; Yes), system 140 and/or client device 104 may provide information to enable the transfer of funds consistent with confirmed transaction assistance parameters associated with the transaction assistance information provided in step 312B (step 318B). In one embodiment, system 140 may, in response to the confirmation, generate and provide information that initiates an EFT based on the parameters accepted by the user. In one example, system 140 may provide the parameter information to another system (e.g., a transaction server, etc.) that is configured to perform transfer transactions in accordance, such as electronically transferring funds (e.g., identified transfer amount) from one or more source accounts to one or more destination accounts, and updates the account information for the respective accounts. In other embodiments, system 140 may be configured to perform such operations.

In response to the transfer operations, system 140 may generate and provide a notification of the transfer of funds (step 320B). In one embodiment, system 140 may be configured to generate, in response to the authorization by the user (e.g., confirmation and subsequent EFT operation), information that may be used to provide content for display, the content including a notification that a transfer of funds from one or more source accounts to one or more destination accounts has occurred. Client device 104 may perform this operation also based on information provided by system 140. For instance, client device 104 may generate an interface with content that is displayed on a display device of client device 104 the generated notification of the transfer transaction.

The disclosed embodiments are, however, not limited to visual notifications suitable for display by client device 104. In additional embodiments, system 140 may generate a tactile notification, an audible notification, or combinations of tactile and audible notifications, which client device 104 may present to the user. Further, in certain aspects, client device 104 may present the generated tactile and/or audible notification to the user concurrently with, or subsequent to, a displayed visual notification.

In other aspects, system 140 may provide the generated second information to a device other than client device 104. In an embodiment, the user may configure one or more rules that cause system 140 to provide the generated second information not to client device 104, but to an additional device specified by the user. For example, client device 104 may correspond to a tablet computer disposed at the user's workplace, and the user may configure system 140 to provide the generated second information to the user's smartphone (e.g., which the user may carry on his or her person).

FIG. 3C shows an exemplary arrangement 300C of transaction assistance configuration rules consistent with disclosed embodiments. In this example, system 140 may generate and store information reflecting the exemplary arrangement 300C that allows the disclosed embodiments to perform instructions consistent with the exemplary rules. For instance, system 140 may generate and store information associated with configuration rules 1-X for a user 1. Configuration rules 1-x may be generated in response to input from user 1 during a configuration process (e.g., process 300A), or may be automatically generated based on programmed conditions in system 140. Each configuration rule may be associated with one or more accounts corresponding to user 1 (e.g., user 1 accounts 1 to 4 (U1A1, U1A2, U1A3, and U1A4). In certain aspects, system 140 may store in memory one or more parameters associated with each user 1 account (e.g., parameter 1, parameter 2, parameter 3, etc.). As exemplified in FIG. 3C, each configuration rule may be associated with instructions that when executed by one or more processors may perform operations consistent with transaction assistance operations of the disclosed embodiments. For example, configuration rule 1 may be a rule that, when executed by system 140, determines whether the current balance of U1A1 is below any proposed transaction assistance operation transfer amount (e.g., when a request to transfer funds from U1A1 is higher than the current balance of U1A1). If the condition is true, configuration rule 1 may prevent the proposed EFT from occurring to avoid withdrawing funds that would result in a negative balance for U1A1. As another example, configuration rule 2 may be a rule that, when executed by system 140, determines whether the current balance of U1A3 (e.g., credit card account) exceeds a threshold value (e.g., $5500.00), which may be designated by user 1 or system 140. If so, the rule may cause system 140 to perform an EFT of a determined transfer amount from U1 A2 (e.g., savings account) to U1A3. In this example, the transfer amount may be determined as a dynamic value, which is a difference between the current balance of U1A3 and the threshold value of $5500.00. In another example, configuration rule 3 may be a rule that, when executed by system 140, determines whether the current balance of U1A1 falls below a determined threshold value (e.g., $1000.00). IF so, system 140 may perform an EFT from U1A2 to U1A1 for a determined transfer amount. In this example, system 140 may determine the transfer amount dynamically (as opposed to a fixed value), which may be a difference between the threshold value (e.g., $1000.00) and the current balance of U1A1. Also, as an example, configuration rule X may be a rule that, when executed by system 140, determines whether the current date of the current month is the 15^{th} or later (e.g., is October 15^{th} or later) and the payment due date parameter for U1 A4 (e.g., mortgage account) is 15 (e.g., reflecting a payment due date on the 15^{th} of each month). Configuration rule X may also enable system 140 to determine whether the transaction history for the current month shows a payment from account U1A1 of at least the minimum payment parameter (e.g., $1800.00) for account 4, and also determine whether U1A1 has a current balance to cover the minimum payment parameter (e.g., $1800.00 or more). If these conditions are met, system 140 may perform an EFT of $1800.00 from U1A1 to U1A4. Other configuration rules may be implemented, generated, defined, and executed by the disclosed embodiments and the examples corresponding to FIG. 3C are not limiting.

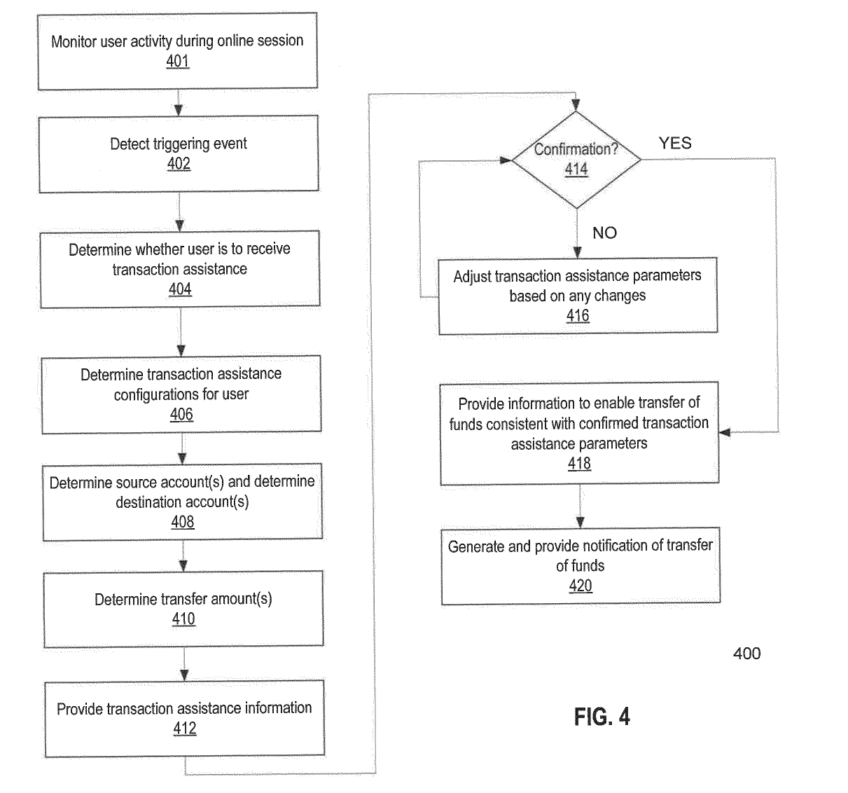

The disclosed embodiments may also include methods and systems for providing transaction assistance based on a user's monitored activities during an online session with an online portal or similar site that provides account management functions (e.g., an online banking website, etc.). FIG. 4 shows a flowchart of an exemplary transaction assistance process consistent with these disclosed embodiments.

In one embodiment, system 140 may provide an online portal that allows users (e.g., user 110) to access account information associated with one or more accounts associated with the users. For example, system 140 may be configured to provide an online account management tool (e.g., website or the like) that user 110 can access over network 120 to perform one or more account management operations. As an example, the online account management tool may allow user 110 to request and view information relating to one or more account parameters for one or more accounts held by user 110. As another example, system 140 may provide the online management tool to allow user 110 to perform account management operations, such as transfer transactions (e.g., EFT, bill payments to an account, etc.).

System 140 may be configured to execute software instructions to perform online user activity monitoring processes. In one embodiment, system 140 may execute an online monitoring program that monitors user 110's online accesses, requests, and similar tasks relating to the user's activities during an online session with the account management tool. In other embodiments, another system may execute the online monitoring program and report results of the monitoring processes disclosed herein to system 140.

In one embodiment, system 140 (or another system that reports results to system 140) may monitor activity during the user's online session with the account management tool (step 401). In one example, system 140 (or the other system that reports results) may track the user's activities by caching or via similar technologies the activities. The tracked information may identify the account(s) that the user requested access to, the sequence of the account(s) accessed, the type of account management functions requested by the user in connection with each account accessed, etc. For example, system 140 may monitor user 110's activities that show user 110 first accessed a checking account and the account management tool provided for display one or more account parameters associated with that account (e.g., balance, etc.). Further, the example, system 140 may also monitor user 110's activities that show user 110's activities accessed a credit card account following the user's access to the checking account. System 140 may also monitor activities associated with the user's access to the credit card account (e.g., clicking and reviewing account balances, transactions, etc.). System 140 may be configured to store the monitored information relating to the user 110's activities during the online session.

As explained, for example, system 140 may provide an online banking portal that allows user 110 to access account information and perform transactions associated with one or more accounts. In addition, as explained, system 140 may execute software instructions that perform monitoring processes that monitor and store (e.g., cache or similar storage mechanisms) user activity relating to his/her online session. In one example, system 140 may track each web page that user 110 may visit at the online portal and the sequence that of the user's visits to the web pages. For instance, system 140 may collect and store information reflecting that user 110 visited a web page that allows user 101 to view account information for a first account (e.g., checking account). System 140 may collect and store information reflecting that user 110 then (after visiting the checking account information page) requested access to account information for a credit card account. System 140 may track other activities, such as functions requested (e.g., account balance check, payment dates confirmations, etc.) using known web-based monitoring and tracking mechanisms. In certain aspects, client device 104 may be configured with tracking software that alone, or in combination with system 140, monitors and stores user activities during online sessions at a designated online portal that provides account management operations (e.g., online banking portal).

In some embodiment, process 400 may also include other operations that are similar to those disclosed above in connection with process 300B, such as operations 402-420 of FIG. 4 and operations 302B-320B of FIG. 3B. In certain aspects, the processes performed in connection with operations 402-420 may include those processes described above in connection with operations 302B-320B, respectively. In one embodiment, operations 406-410 may include additional operations associated with the monitored user activity during the online session. For example, system 140 may be configured to determine configurations for user 110 that may relate to determining one or more source accounts and/or one or more destination accounts, and/or one or more transfer amount(s) for a transaction operation to be performed. For instance, system 140 may perform processes that determine a source account and a destination account in operation 408 based on the stored monitored information of the user's activities during an online session with the account management tool provided by system 140 (or another system). Following the example above where user 110 may have accessed a checking account followed by a credit card account through the online account management tool, system 140 may determine the checking account as a source account and the credit card account as a destination account. In this example, the disclosed embodiments provide mechanisms that automatically prefill content as source and/or destination accounts based on the user's online session activities. In other embodiments, system 140 may determine such accounts also based on the triggering event detected in operation 402. For example, in one embodiment, system 140 may determine the source and/or destination account(s) and/or transfer amount(s) based on a triggering event such as user 110 requesting a transfer operation (e.g., selecting a transfer request option displayed on an interface of client device 104). System 140 may also determine source and/or destination accounts, transfer amount(s) etc. based on a period of time between the triggering event and the last user activity monitored and stored during operation 401. The examples above are not limiting to the disclosed embodiments. System 140 may be configured to consider other monitored online user activities, triggering events, time frames, etc. when determining one or more source accounts, one or more destination accounts, and/or one or more transfer amount(s).

In some aspects, system 140 may determine the source and/or destination accounts based on a type of currency associated with the user's activities (e.g., a currency in which the requested transfer operation is denominated). For example, system 140 may determine that the transaction is denominated in Canadian dollars, and may identify a source account and/or a destination account that are also denominated in Canadian dollars, and additionally or alternatively, are held at a Canadian financial institution. The disclosed embodiments are, however, not limited to transactions denominated in Canadian dollars, and in additional embodiments, the transaction assistance configurations may include rules that specify source and/or destination accounts for transaction denominated in U.S. dollars, Euros, Japanese yen, Chinese renminbi, and any additional or alternate currency appropriate to system 140 and the user.

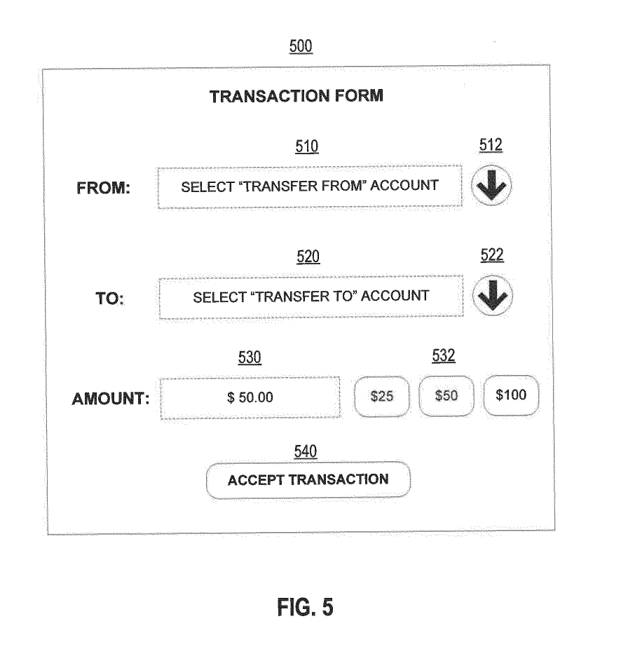

As described herein, the disclosed embodiments enable system 140 to provide information identifying one or more of source account, a destination account, and a transfer amount associated with one or more transfer operations (e.g., electronic funds transfer (EFT) transactions) to client device 104. In some aspects, client device 104 may receive the transmitted information for presentation to user 110 within a corresponding user interface. FIG. 5 illustrates an exemplary user interface 500 for transfer transactions that include information, such as account information and/or transfer amounts.

In some aspects, interface 500 may be presented within a web page or online portal associated with system 140, or alternatively, interface 500 may be presented within a pop-up window, email message, or other transmission to client device 104 (e.g., transaction assistance information provided by system 140). Interface 500 may include a source account selection field 510 indicating a source account from which funds involved in the transfer transaction will be drawn. In one aspect, an option selector 512, which may be integrated into, or separate from, field 510, allows a user to input a source financial account or select from a list of accounts associated with the user (e.g. savings account, checking account, credit card account). In one embodiment, system 140 may generate the list from user account data stored in repository 144.

Interface 500 may also include a destination account selection field 520 indicating a destination account for the transfer transaction, an option selector 522 (which may be integrated or separate from selection 520) that may allow user 110 to select or input the destination account (e.g. a different financial account, a utility company account, a credit card account, a third person's account (e.g., a second user's account), etc.).

In some embodiments, interface 500 may include a transfer amount field 530 indicating an amount of funds to be transferred in the transfer transaction. In addition to transfer amount field 530, interface 500 may also include one or more transfer amount options 532, which may include predetermined options (e.g. $25, $100) that system 140 may determine in accordance with the disclosed embodiments. In certain embodiments, interface 500 may include an interface element 540 that allows the user to authorize the transfer transaction configured on interface 500.

As described, the disclosed embodiments may perform processes that analyze account parameters, transaction history information, and other account information to provide transaction assistance (e.g., prefill information used to complete or perform transfer operations, etc.). For example, system 140 may be configured to determine, based on an analysis of account and transaction history information, that a user has a habit of transferring $50 from her personal checking account to her child's savings account every two weeks. In some aspects, user 110 may select a checking account in source selector 512 and the child's savings account in the destination selector 522. Client device 104 may execute software instructions to transmit the selected source and destination account and transfer amount information to system 140.

In some embodiments, system 140 may receive the transmitted selections, and may execute software instructions to identify one or more additional parameters of the transfer transaction. For example, system 140 may execute software instructions to identify patterns of transactions based on user profile data stored in data repository 144, and to identify additional transaction parameters, which include a transfer amount, based on the transaction patterns. In some aspects, system 140 may identify, based on the source account, the destination account, and identified transaction patterns, that user 110 would likely select 50 as the transfer amount.

System 140 may execute software instruction to transmit the determined transfer amount to user device 104, which may process and display the transfer amount within amount selection window 530 of interface 500.

In other embodiments, system 140 may execute software instructions to identify one or more potential transfer amounts based on the source account, the destination account, and/or the identified transaction history. System 140 may provide information identifying the potential transfer amounts to client device 102, which may render the information for presentation within amount selection options 532 of interface 500. In further embodiments, amount selection options 532 of interface 500 may provide user 110 with a continuous range of potential transfer amounts that may be specified using of a corresponding element, such as a slider bar (not shown). For example, the slider bar enables user 110 to modify the transfer amount within predetermined ranges in accordance with predetermined increments (e.g., between $0 and $100, starting at $50, with slider increments of $5).

System 140 may also perform processes that identify one or more default values for various transaction parameters from user profile data, which may be configured by a user in advance. For instance, the user may select a default financial account for a transaction source account field 510 (e.g. default to user's checking account), or may select default amount values based on other parameter selections (e.g. when user selects child's checking account, user may select default amount of $50). In addition, the system 140 may be configured to allow a user to modify transaction parameters from those identified and provided by the system.

In other exemplary embodiments, system 140 may be configured to analyze historical transactions and identify patterns. System 140 may use such identified patterns to determine transaction parameters of interest to a user, and generate transaction assistance information to provide to client device 104 for display to the user (e.g., transaction forms preconfigured with one or more identified transaction parameters). For instance, a user may have a history of transferring funds from a checking account to a savings account the first day of every month. System 140 may determine this pattern by analyzing transaction history information, and based on the pattern, determine the user's checking account as a source account, the user's savings account as a destination account, and the amount of funds for the transfer amount.

In certain embodiments, system 140 may be configured to generate a triggering event based on the determined pattern information. For example, system 140 may be configured to generate and provide an alert to the user, via client device 104, on the first day of every month requesting whether the user would like to make a transfer to their savings account. In one example, the disclosed embodiments may generate the alert such that the user may select a single button or option to authorize the preconfigured transfer transaction. In other embodiments, the alert may direct client device 104 to provide the user via a display device, a transaction form 500 including the prefilled source account, destination account, and transfer amount parameters.

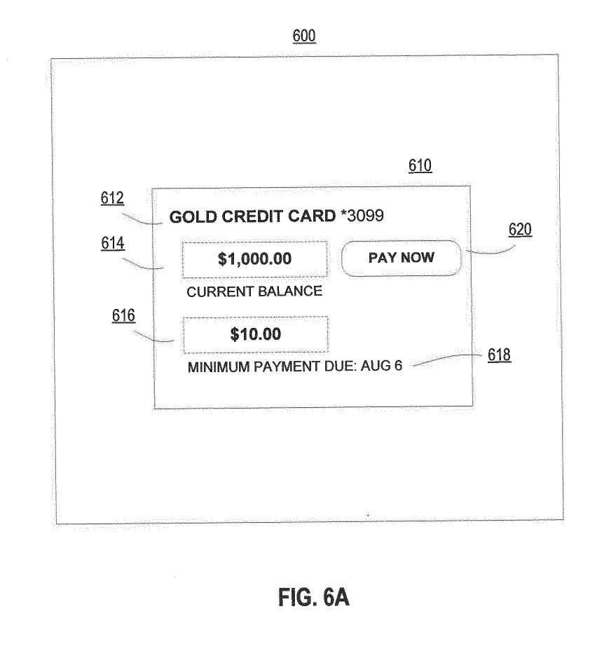

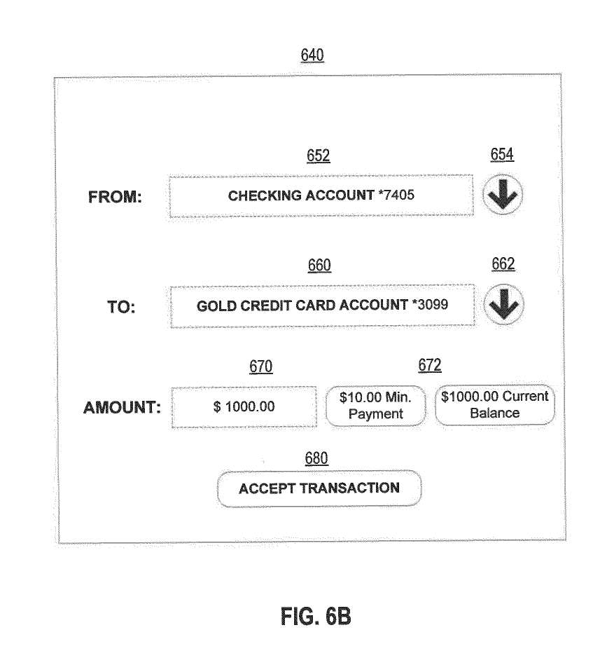

FIG. 6A shows an exemplary interface 600 consistent with certain embodiments. In one aspect, interface 600 may be displayed by client device 104 based on transaction assistance information received by system 140 in accordance with the disclosed embodiments.

In one embodiment, system 140 may be configured to detect a triggering event, such as a transaction a user would likely be interested in making based on, for example, historical or pattern information related to account 612. For example, as discussed above, system 140 may recognize transaction patterns based on a user's historical transactions, the system may identify bills with upcoming due dates and relevant balances, or identify any other likely transaction or transaction parameter based on configuration rules or user profile data.

In this example, a user may have a credit card bill due August 6th, with a current balance of $1,000 and minimum payment of $10. System 140 may be configured to obtain information comprising this information from the data repository 144, a payment system, user device 104, or other system or source. System 140 may determine one or more relevant transaction parameters (e.g. credit card account as a destination account, current balance, minimum payment, due date, etc.), and generate electronic instructions to prefill a transfer transaction that can be automatically performed or performed in response to a single (or more than one) user input. For example, the disclosed embodiments may configure interface 600 to include content 610 that includes information identifying a destination account 612, a current balance of the account 614, and a transfer amount for a bill payment 616. Content 610 may also include an authorization selection 620 that, when selected, initiates the transfer of the transfer amount to the destination account 612. In the example of FIG. 6A, interface 610 does not include content identifying the source account. In certain embodiments, the source account may be identified in content 610. In this example, system 140 may have determined the source account (e.g., a user checking account, etc.) based on configuration rules set by the user, but does not provide information used to display content that identifies the source account. In other embodiments, the source account may be identified in content 610

FIG. 6B shows an exemplary interface 640 consistent with disclosed embodiments. Interface 640 may be generated and provided based on transaction assistance information provided by system 140. In one aspect, interface 640 may be displayed on a display device of client device 104.

In this example, interface 640 may comprise transaction parameters such as a source account field 652 and option selector 654, a destination account field 660 and option selector 662, a transfer amount field 670, and one or more preconfigured transfer amount options 672. Following the example above in connection with FIG. 6A, the disclosed embodiments may determine and prefill as the source account field 652 the user's checking account, and prefill the destination account field 660 the user's credit card account. In this example, system 140 may have determined the transfer amount based on the current balance of the credit card account, which in this example may be $1000. In other embodiments, system 140 may determine other prefilled transfer amount options 672 for the user to select. In this example, system 140 may have determined preconfigured transfer amount options 672, such as a minimum payment, current balance, or other values (e.g. 50% of current balance, $100 default amount, etc.). In one embodiment, system 140 and/or client device 104 may perform processes that enables the user to adjust the transfer amount using user-interactive input features, such as a slider bar or other modification selector that allows the user to more finely adjust the transfer amount. The disclosed embodiments may allow such modification selectors to have boundaries, such as a starting point and bounds based on identified parameters (e.g., account balances, etc.). Interface 640 may also include an authorization input 680, or other interface element, to allow the user to accept and complete the transaction as configured on interface 640.

The disclosed embodiments also include methods and systems that enable a user to “top off” an account balance based on preconfigured transaction assistance configuration rules. For example, the disclosed embodiments may allow, for example, system 140 to provide configuration options for user 110 to select a destination account that is to have a minimum account balance (e.g., $500.00). Based on these configurations, system 140 may perform processes that track the account balance of the account to determine when the account balance falls below the identified threshold value (e.g., $500.00). When it does, system 140 may generate and provide transaction assistance information that is used by client device 104 to display an interface with an option for the user to “top off” the designated account. When selected (e.g., single click, etc.), system 140 may be configured to automatically transfer funds from a predetermined account (e.g., savings account, etc.) to the top off account to ensure the $500.00 balance is maintained. In certain aspects, system 140 may be configured (e.g., based on configuration rule(s)) to transfer a specified amount to the top off account (e.g., $200.00, 500.00, etc.). In other aspects, system 140 may determine the difference between the threshold account balance value (e.g., $500.00) and the current account balance of the top off account, and transfer the difference of the two from the predetermined account to the top off account. In other embodiments, system 140 may automatically perform the transfer of funds to top off the top off account without requiring user authorization (e.g., no single click required).

In certain embodiments, system 140 may be configured to detect an event triggering an electronic transfer of funds between accounts held by a user (e.g., user 110 of FIG. 1). Using any of the exemplary techniques described above, and in response to the detected triggering event, system 140 may automatically identify values of one or more parameters that facilitate an initiation and completion of an electronic funds transfer (EFT) transaction between the accounts of user 110 (and other users), and may provide the identified parameter values to a device associated with user 110 (e.g., device 104 of FIG. 1). By way of example, the identified parameter values may include, but are not limited to, an identifier of a source account for the electronic funds transfer, an identifier of a destination account for the EFT transaction, and/or an amount of the EFT transaction.

In some aspects, device 104 may be configured to present an interface associated with the electronic funds transfer transaction (e.g., an EFT transaction interface), and further to populate automatically one or more portions of the EFT transaction interface with corresponding ones of the identified parameter values. For example, using the exemplary techniques described above, device 104 may automatically fill portions of a presented web page or graphical user interface with corresponding values of the source account, destination account, and/or transfer amount, and may enable user 110 to confirm the prefilled parameters values and complete the EFT transaction in accordance with the prefilled parameter values by clicking on, touching, or otherwise selecting a predetermined portion of the EFT transaction interface (e.g., authorization input region 680 of FIG. 6B).

By automatically identifying and prefilling portions of web pages, GUIs, and other EFT transaction interfaces with parameter values facilitating EFT transactions, the disclosed embodiments may enable user 110 to more accurately monitor the status of one or more user accounts, as well as the mundane, but often numerous, electronic funds transfers that facilitate user 110's electronic transactions (e.g., prescheduled electronic bill payments, online purchases linked to user 110's checking account, purchase transactions using a credit card account within user 110's mobile wallet, etc.). Further, by automatically prefilling portion of the EFT transaction interfaces without user input, the disclosed embodiments reduce a time required by user 110 to identify and specify appropriate values of the parameters supporting the electronic funds transfers.

Further, by enabling user 110 to confirm and complete the EFT transaction through a single action, the disclosed embodiments may improve the ability of user 110 to monitor account statuses and/or confirm electronic funds transfer through interfaces presented on wearable computing devices (e.g., smart watches), embedded computing devices, and other computing devices with display units of reduced size and/or functionality. In certain instances, the disclosed embodiments may improve the functionality and operation of wearable, embedded, and other similar computing devices when performing account management processes.

In some embodiments, one or more of the detected triggering events may correspond to an action performed or initiated by user 110 (e.g., through a web page or graphical user interface presented by device 104). By way of example, user 110 may, through device 104, access a web page or graphical user interface (e.g., a GUI provided by an executable “app”), and may further access a portion of the interface that enables user 110 to request an electronic funds transfer (EFT) transaction between one or more accounts held by user 110. In certain aspects, user 110's access of and interaction with the EFT transaction interface may be detected by system 140 as a triggering event (e.g., a “user-generated” triggering event). Further, upon detection of the user-generated triggering event, system 140 may automatically identify values of one or more parameters that facilitate an initiation and completion of the EFT transaction (e.g., a source account, a destination account, and/or a transfer amount) using any of the exemplary techniques outlined above. System 140 may, in some aspects, transmit the identified parameter values to device 104, which may be configured to prefill portions of the EFT transaction interface with corresponding ones of the identified parameter values, as outlined above.

In other aspects, user 110 may initiate a purchase transaction with an online retailer using an account held by user 110 at a financial institution associated with system 140 (e.g., through a web page or graphical user interface), and system 140 may be configured to detect the initiated purchase transaction as a user-generated event triggering an EFT transaction. As outlined above, system 140 may automatically identify values of one or more parameters that facilitate an EFT transaction (e.g., source account, destination account, and/or transfer amount) in support of the initiated purchase transaction, and system 140 may transmit the identified parameter values to device 140 across network 120. In certain aspects, and in response to the received parameter values, device 140 may be configured to present a notification alerting user 110 to the potential EFT transaction, and additionally or alternatively, present to user 110 an EFT transaction interface (e.g., interface 640 of FIG. 6B) having fields prefilled with portions of the received parameter values, as described above. For instance, user 110 may initiate an online purchase transaction involving a credit card account held by user 110, and using the disclosed embodiments, device 104 may be configured to present to user 110 an EFT transaction interface prefilled with content enabling user 110 to transfer all or a portion of the purchase amount from a checking or savings account to the credit card account.

The disclosed embodiments are, however, not limited to exemplary user-generated triggering events that include user 110's access of an EFT transaction interface and user 110's initiation of a purchase transaction with an electronic retailer. In other aspects, user-generated triggering events consistent with the disclosed embodiments may include, but are not limited to, user 110's access of interfaces providing electronic banking and account management services, user 110's access to interfaces providing investment management services or electronic trading services, a withdrawal or deposit by user 110 at an automated teller machine (ATM), a purchase by user 110 at a physical point-of-sale (e.g., using an electronic wallet maintained on device 104), and any additional or alternate activity of user 110 detectable by system 140 and triggering an EFT transaction between accounts held by user 110 and/or other individuals.

In some embodiments, system 110 may be configured to detect one or more system-generated events that trigger and EFT transaction automatically and without input from or affirmative action by user 110 (e.g., as provided through a web page or other interface presented by device 104). By way of example, system 140 may be configured access and monitor data associated with one or more accounts held by user 110 (e.g., account data 144B) and one or more transactions involving user 110's accounts (e.g., transaction data 144C), and based on the monitored account and transaction data, detect an occurrence of a system-generated event that triggers an EFT transaction between accounts held by user 110 and others (e.g., in step 402 of FIG. 4).

In certain aspects, the system-generated event may include, but is not limited to, a system-generated event based on rules specified by user 110 (e.g., an alert generated when a balance of a user-specified account falling below a predetermined or user-specified threshold, an alert generated based on a user-specified due date for a bill, etc.), a default system-generated event associated with one or more of user 110's accounts (e.g., an alert based on a minimum balance of a checking or savings account, an alert based on a maximum credit limit associated with a credit card account, etc.), and an event programmatically identified by system 140 (e.g., a recurrent electronic bill payment identified based on stored prior session data and/or stored transaction data, a margin call associated with an investment or brokerage account held by user 110, etc.). In some instances, using the exemplary processes described above, user 110 may access a website, graphical user interface, or other online portal to establish and configures one or more of the user-specified rules, which may be stored locally by system 140 (e.g., in database 144).

Upon detection of the occurrence of the system-generated event, and using any of the exemplary techniques outlined above, system 140 may automatically identify values of one or more parameters that facilitate the triggered EFT transaction, such as a source account, a destination account, and/or a transfer amount (e.g., in steps 408 and 410 of FIG. 4). System 140 may, in some aspects, transmit the identified parameter values to device 104 across network 120 (e.g., in step 402 of FIG. 4). In response to the received parameter values, device 140 may be configured to present a notification alerting user 110 to the potential EFT transaction, and additionally or alternatively, present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680) to confirm the prefilled parameter values (or to confirm user-specified modifications), and upon receipt of the confirmation from device 104, system 140 may be configured to execute the corresponding EFT transaction in accordance with the confirmed parameter values (e.g., in step 418 of FIG. 4). As outlined above, system 140 may provide a notification of the completed EFT transaction to device 104, which may process and render the provided notification for presentation to user 110 (e.g., in step 420 of FIG. 4).

In certain embodiments, system 140 may also be configured to detect an occurrence of a system-generated event that results from a transaction initiated by user 110 (e.g., a transaction to purchase goods or services from an online retailer through a web page or interface presented by device 104). By way of example, user 110 may, through client device 104, make an impulse purchase of $500 in goods from an online retailer using a credit card account. Further, in some instances, a current account balance of the credit card account may be $1,750, and the disclosed embodiments may enable user 110 (e.g., through an online portal presented by device 104) to establish an event triggering an EFT transaction when the current account balance of the credit card account exceeds a user-specified threshold of $2,000. In some aspects, using any of the exemplary processes outlined above, system 140 may be configured to detect the initiated purchase transaction in the amount of $500, and further, to determine, based on the user-established event, that the purchase amount of $500 would increase the current account balance of the credit card to $2,250, which falls above the $2,000 threshold imposed by the user.

In an embodiment, and in response to the determination that the potential purchase transaction would increase the current account balance above the user-specified threshold, system 140 may be configured to generate an electronic command that suspends an execution of the purchase transaction and stores information associated with the purchase transaction in a corresponding data repository (e.g., database 144 and/or cloud-based storage accessible across network 120). The stored information may, in certain aspects, include an initiation time, the purchase amount, account information, retailer information, and/or authentication information, and any additional or alternate information that enables system 140 to execute that purchase transaction at a later time without additional input from or affirmative action by user 110.

Upon suspension of the purchase transaction, and using any of the exemplary processes outlined above, system 140 may be configured to automatically identify values of one or more parameters of an EFT transaction (e.g., a source account, a destination account, and/or a transfer amount) that, in some embodiments, facilitate a completion of the suspended purchase transaction by user 110. By way of example, the disclosed embodiments may be configured to identify user 110's credit card account as a destination account, user 110's savings or checking account as a source account, and a transfer amount of 251 (e.g., that would result in a credit card account balance of $1,999 (i.e., less that the user-specified limit) after completion of the purchase transaction).

System 140 may, in some aspects, transmit the identified parameter values and information identifying the suspended transaction to device 104 across network 120. In response to the received information and parameter values, device 140 may be configured to generate and present a notification that alerts user 110 to the suspended purchase transaction and additionally or alternatively, that indicates that the initiated purchase transaction would result in a credit card account balance exceeding user 110's specified threshold of $2,000. Device 140 may be further configured to render and present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680 of FIG. 6) to confirm the prefilled parameter values (or to confirm user-specified modifications), and upon receipt of the confirmation from device 104, system 140 may be configure to execute the corresponding EFT transaction in accordance with the confirmed parameter values. As outlined above, system 140 may provide a notification of the completed EFT transaction to device 104, which may process and render the provided notification for presentation to user 110.

Furthermore, the completed EFT transaction may reduce the current balance of user 110's credit card account to an amount (e.g., $1,499) capable of accommodating the purchase transaction of $500 without exceeding the user-specified threshold of $2.000. In certain embodiments, system 140 may be configured to generate electronic commands to automatically complete the execution of the suspended purchase transaction without input from or affirmative action by user 110, and provide information to device 104 that confirms the execution of the purchase transactions. Device 104 may, in some instances, render the received information for presentation to user 110 as a notification of the completed purchase transaction.

The disclosed embodiments are, however, not limited to processes that suspend purchase transactions of goods or services from online retailers based on a detection of an occurrence of an event triggering an EFT transaction between one or more of user 110's accounts. In other embodiments, and based on a detection of one or more triggering events, system 140 may be configured to suspend a transaction to purchase one or more securities initiated by user 110 (e.g., through a web page or interface presented by device 104) or on behalf of user 110 by a broker using a corresponding brokerage system or terminal (e.g., associated with system 140).

For instance, user 110 may access a website, graphical user interface, or other online portal associated with an online brokerage (e.g., provided by or associated with system 140), and may regularly adjust a composition of an investment portfolio by purchasing and selling securities on one or more markets (e.g., the Toronto Stock Exchange (TMX™, the New York Stock Exchange (NYSE™) NASDAQ™, etc.). In some instances, user 110 may also maintain an account (e.g., a brokerage account) into which a system of the online brokerage (e.g., system 140) transfers funds accumulated through the sales of the securities, and further, from which system 140 draws funds to support purchases of securities).

Further, in some instances, user 110 may monitor market indices for one or more markets during an especially turbulent trading session, and may submit (e.g., to the system 140 through the website, graphical user interface, or online portal) orders to purchase securities that user 110 deems are undervalued by the market. Due to the volatile trading session, user 110 may not adequately monitor a balance of the brokerage account, and one or more of the orders may deplete the funds within the brokerage account below a threshold level specified by the user (e.g., using any of the configuration processes described above).

In an embodiment, system 140 may detect that at least one of the submitted orders would reduce a balance of user 110's brokerage account below the user-specified threshold (and additionally or alternatively, would overdraw the account). System 140 may be configured to generate an electronic command that suspends an execution of the at least one submitted order, and that stores order information associated with the at least one order in a corresponding data repository (e.g., database 144 and/or cloud-based storage accessible across network 120). The stored order information may, in certain aspects, include a time associated with the at least one suspended order, identifiers and quantities of securities associated with the at least one suspended order, offer prices of the securities, authentication information, and any additional or alternate information that enables system 140 to execute that at least one suspended order and purchase the securities at a later time without additional input from or affirmative action by user 110.

Upon suspension of the at least one submitted order, and using any of the exemplary processes outlined above, system 140 may be configured to automatically identify values of one or more parameters of an EFT transaction (e.g., a source account, a destination account, and/or a transfer amount) that, in some embodiments, would increase the current balance of user 110's brokerage account above the user-specified threshold and facilitate an execution of the at least one suspended order. By way of example, the disclosed embodiments may be configured to identify user 110's brokerage account as a destination account, identify user 110's savings or checking account as a source account, and identify a transfer amount that includes funds sufficient to offset the cost of the purchased securities and result in a brokerage account balance that is equivalent to or exceeds the user-specified threshold.

System 140 may, in some aspects, transmit the identified parameter values and information identifying the suspended order to device 104 across network 120. In response to the received information and parameter values, device 140 may be configured to generate and present a notification alerting user 110 to the suspension of the at least one submitted order and additionally or alternatively, indicating that the at least one submitted order would result in a brokerage account balance that falls below the user-specified threshold. As described above, device 104 may be further configured to render and present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680) to confirm the prefilled parameter values (or to confirm user-specified modifications). Upon receipt of the confirmation from device 104, system 140 may be configured to execute the corresponding EFT transaction in accordance with the confirmed parameter values. As outlined above, system 140 may provide a notification of the completed EFT transaction to device 104, which may process and render the provided notification for presentation to user 110.

Furthermore, the completed EFT transaction may increase the current brokerage account balance to a value that would accommodate the at least one submitted order and remain above the user-specified threshold. In certain embodiments, system 140 may be configured to generate an electronic command that automatically executes the at least one suspended order in accordance with the stored information and business logic associated with the online brokerage and purchases the securities without input from or affirmative action by user 110. System 140 may, for example, provide information to device 104 that confirms the execution of the suspended order and the purchase of the securities, and device 104 may render the received information for presentation to user 110 as a notification of the completed order and purchased securities.

The disclosed embodiments are, however, not limited to processes that suspend user-submitted orders to purchase securities in response to occurrences of one or more events triggering an EFT transaction (e.g., a brokerage account balance that falls below a user-specified threshold). In other instances, system 140 may be configured to execute processes that automatically rebalance a composition of an investment portfolio held by user 110. The rebalancing processes implemented by system 140 may, for example, generate orders to buy or sell one more securities without input from user 110, and depending on a composition of the rebalanced portfolio, a balance of user 110's brokerage account may fall below a user-specified threshold. In certain aspects, system 140 may be configured to perform any of the exemplary processes described above to suspend the rebalancing process (and the execution at least one of the generated orders), generate information identifying parameters values of an EFT transaction appropriate to maintain the brokerage account balance above the user-specified threshold, and transmit the identified parameter values to device 104.

As described above, and in response to the received parameter values, device 104 may be configured to render and present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680 of FIG. 6B) to confirm the prefilled parameter values (or to confirm user-specified modifications). Upon receipt of the confirmation from device 104, system 140 may be configured to execute the corresponding EFT transaction in accordance with the confirmed parameter values. As outlined above, system 140 may provide a notification of the completed EFT transaction to device 104, which may process and render the provided notification for presentation to user 110. Further, as the completed EFT transaction may maintain the brokerage account balance above the user-specified threshold during the rebalancing process, system 140 may be configured to generate electronically commands that automatically complete the suspended rebalancing process in accordance with the stored information and business logic associated with the online brokerage and that purchase and/or sell the securities without input from or affirmative action by user 110. System 140 may, for example, provide information to device 104 that confirms the completion of the suspended rebalancing process, and device 104 render the received information for presentation to user 110 as a notification of the completed order and purchased securities.

In other aspects, and due to significant and unexpected losses in the securities held within user 110's investment portfolio, the online brokerage associated with system 140 (and additionally or alternatively, another computer system in communication with system 140 and device 104 across network 120) may generate a margin call that requires user 110 to increase an amount of cash within user 110's brokerage account and additionally or alternatively, to sell one or more securities held within user 110's investment portfolio to generate the required cash.

In an embodiment, system 140 may obtain information identifying the margin call, and in particular, the funds required for deposit in user 110's brokerage account, and may determine that the identified margin call corresponds to a system-generated event that triggers an EFT transaction between accounts held by user 110 (e.g., in step 402 of FIG. 4). Using any of the exemplary techniques described above, system 140 may automatically identify values of one or more parameters that facilitate the EFT transaction triggered by the detected margin call (e.g., a source account, a destination account, and/or a transfer amount). For example, the margin call may require a transfer to $1,000 in funds to user 110's brokerage account, and system 140 may identify user 110's checking account as the source account and user 110's brokerage account as the destination account (e.g., in step 406 of FIG. 4). Further, by way of example, system 140 may determine a transfer amount for the ETF transaction based on the funds required by the margin call (e.g., $1,000), and additionally or alternative, and additional transfer amount that would maintains the balance of user 110's brokerage account above a user-specified threshold value (e.g., in step 410 of FIG. 4). In certain instances, and as described above, system 140 may be configured to select the source account, the destination account, and/or the transfer amount based on, among other things, one or more rules specified by user 110, the online brokerage, and/or the financial institution, business logic associated with the financial institution and/or the online brokerage, data indicative of balances of accounts held by user 110 (e.g., account data 144B), and a history of prior transactions based on stored transaction data (e.g., transaction data 144C) and/or monitored activity of user 110 in prior online sessions.

System 140 may, in some aspects, transmit the identified parameter values to device 104 across network 120 (e.g., in step 412 of FIG. 4). In response to the received parameter values, device 140 may be configured to present a notification alerting user 110 to the EFT transaction that facilitates the margin call, and additionally or alternatively, present to user 110 an EFT transaction interface (e.g., interface 640 of FIG. 6B) having field prefilled with portions of the received parameter values. Using the techniques described above, user 110 may click, touch, or otherwise select a predetermined portion of the EFT transaction interface (e.g., authorization portion 680) to confirm the prefilled parameter values (or to confirm user-specified modifications), and upon receipt of the confirmation (e.g., in step 414 of FIG. 4), system 140 may be configured to execute the corresponding EFT transaction in accordance with the confirmed parameter values (e.g., in step 418 of FIG. 4).

As outlined above, system 140 may provide a notification of the completed EFT transaction to device 104, which may process and render the provided notification for presentation to user 110 (e.g., in step 420 of FIG. 4). In certain aspects, the presented notification may confirm the execution of the EFT transaction in accordance with the transfer parameter values and may confirm that the execute EFT transaction satisfied the margin call.

In the exemplary embodiments described above, system 140 may obtain, data identifying one or more users and devices (e.g., user 110 and device 104), data identifying accounts held by user 110 and issued by a financial institution associated with system 140 and/or by other issuers, and further, data identifying purchases and financial services transactions initiated by user 110 and involving one or more of the accounts of user 110. In certain embodiments, system 1140 may be configured to analyze the stored customer, account and transaction data, and may track user 110's spending in one or more predetermined or specified product categories to generate contextual data that characterizes user 110's preferences for specific types or categories of products and purchases.

By way of example, the stored transaction data (e.g., transaction data 144B) may include data records corresponding to discrete transactions to purchase goods or services (e.g., purchase transactions) initiated by user 110. For each discrete purchase transaction, the corresponding data record may identify a purchase time, a transaction amount, an account number, a type or category of a purchased good or service, and additionally or alternatively, information identifying of a point-of-sale device that processed the transaction. Further, in some instances, the stored customer data (e.g., customer data 144A) may include data records that associate user 110 within corresponding positional data and corresponding time stamps. By way of example, system 140 may receive at least a portion of the positional data from a positioning system incorporated into a device of user 110 (e.g., device 104), and additionally or alternatively, from a third-party positioning system in communication with devices 104 and system 140 across network 120.

In some aspects, system 140 may be configured to analyze transaction data 144B to determine that user 110 purchases coffee from a local retailer each weekday during two temporal periods (e.g., between 9:10 a.m. and 9:35 a.m., and between 2:25 p.m. and 3:00 p.m.). Further, based on an analysis of the positional data records of customer data 144B, system 140 may determine that at the time of each coffee purchase, user 110 is disposed a geographic positions clustered about a local Starbucks™. By way of example, the clustered geographic positions disposed about the local Starbucks™ may establish a virtual geographic boundary (e.g., a “geo-fence”) that bounds the geographic positions of user 110's daily coffee purchases.

In other aspects, system 140 may be configured to analyze transaction data 144B to determine that user 110 purchases groceries and other goods from a retailer (e.g., a local Costco™) each Saturday morning between 10:30 a.m. and 11:10 a.m. and in amounts ranging from $150 to $200. Based on an analysis of the positional data records of customer data 144B, system 140 may identify a geographic position of user 110 at the time of each Costco™ purchase, and may establish a corresponding geo-fence that bounds at least a portion of the identified geographic positions and corresponds to the Costco™ retailer.

System 140 may, in some aspects, be configured to establish contextual data for user 110 that incorporates and links together information identifying corresponding ones of the established geo-fences, the temporal periods associated with prior purchase transactions, and/or the amounts of the prior purchase transactions. System 140 may be configured to store the generated contextual data within a corresponding data repository (e.g., data repository 144 and/or a cloud-based data repository accessible to system 140 across network 120).

In some embodiments, system 140 may compare a current geographic position of user 110 at a current time (e.g., as obtained from a positioning system of device 104) against a portion of the stored contextual data to detect a contextual event that would trigger an electronic funds transfer (EFT) transaction between accounts held by user 110 and/or others. In certain aspects, the detected contextual event (i.e., a contextual triggering event) may represent an expected occurrence of a purchase transaction that, based on prior purchase transactions, involves a corresponding account of user 110. By way of example, system 140 may determine that a current geographic position of device 104 (and thus, of user 110) falls within a geo-fence established for a local Costco™ retailer (e.g., that surrounds geographic positions of prior purchases by user 110 at the Costco™ retailer). Further, system 140 may also determine that device 104's geographic position crossed the geo-fence associated with Costco™ during at 10:40 a.m. on a Saturday morning, which falls within a temporal period associated with user 110's prior purchases at Costco™.

In some aspects, and based on user 110's position within the Costco™ geo-fence at a time associated with prior Costco™ purchases, system 140 may determine that user 110 is expected to make a purchase at the local Costco™ retailer in an amount consistent with prior purchase amounts (e.g., between $150 to $200). Further, based on user 110's history of prior transactions (e.g., within transaction data 144B), system 140 may determine that user 110 is likely to initiate the purchase transaction at Costco™ using a debit card linked to a checking account held by user 110.

In one embodiment, system 140 may establish user 110's expected Costco™ purchase (e.g., in amount of $150 to $200 using the debit card) as a contextual event triggering an electronic funds transfer (EFT) transaction. In some aspects, the disclosed embodiments may be configured to present, to user 110 though device 104, an EFT interface (e.g., a web page or other graphical user interface) prefilled with content that enables user 110 to confirm and initiate the EFT transaction to transfer funds to cover the expected Costco™ purchase from another account into user 110's checking account.

By way of example, and using any of the exemplary techniques described above, system 140 may automatically identify values of one or more parameters that facilitate the EFT transaction, such as a source account, a destination account, and/or a transfer amount (e.g., in steps 408 and 410 of FIG. 4). For instance, based on the expected Costco™ transaction using the debit card, system 140 may identify user 110's checking account as the destination account, may identify user 110's savings account as the source account, and further, may identify the transfer amount as $200 (i.e., the maximum value of prior purchase transaction).

System 140 may, in some aspects, transmit the identified parameter values to device 104 across network 120 (e.g., in step 412 of FIG. 4). In response to the received parameter values, device 140 may be configured to present a notification alerting user 110 to the EFT transaction, and additionally or alternatively, present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680) to confirm the prefilled parameter values (or to confirm user-specified modifications), and upon receipt of the confirmation from device 104, system 140 may be configured to execute the corresponding EFT transaction in accordance with the confirmed parameter values (e.g., in step 418 of FIG. 4). As outlined above, system 140 may provide a notification of the completed EFT transaction to device 104, which may process and render the provided notification for presentation to user 110 (e.g., in step 420 of FIG. 4).

Through the disclosed embodiments, system 140 may be configured to present, to user 110, an opportunity to initiate an EFT transaction that increases an account balance of user 110's checking account in advance of an expected purchase transaction that would draw from the checking account. In certain aspects, the disclosed embodiments may proactively increase the current balance of the checking account to accommodate the expected purchase transaction before user 110 initiates the expected purchase transaction at the Costco™ retailer.

In other aspects, system 140 may adaptively determine whether to present user 110 with the opportunity to initiate the ETF transaction based on a potential impact of the expected purchase transaction on user 110's checking account balance. For example, and as described above, user 110 may establish a rule (e.g., through an online portal presented by device 104) that triggers an EFT transaction when a current account balance of the checking account falls below a user-specified threshold of $2,000.

System 140 may, in certain aspects, identify the expected purchase transaction involving the Costco™ retailer, and determine that the expected transaction amount between $150 and $200 would not reduce the current balance of user 110's checking account below the user-specified threshold of $2,000. Based on the determination, system 140 may decline to present the opportunity to initiate the ETF transaction to user 110. If, however, system 110 were to determine that the current account balance of user 110's checking account already falls below the user-specified threshold, or alternatively, if system 140 were to determine that the expected purchase transaction amount would reduce the current balance of user 110's checking account below the user-specified threshold, system 140 may be configured to present—the opportunity to initiate the ETF transaction to user 110 prior to the initiation of the expected purchase transaction using any of the exemplary techniques outlined above.

In other embodiments, system 140 may monitor stored data indicative of one or more prior purchase transactions initiated by user 110 (e.g., as stored in transaction data 144C) to characterize user 110's spending in one or more product categories (e.g., coffee, gas, means, and/or impulse purchases of goods and services) over corresponding time periods (e.g., daily, monthly, weekly, etc.). In certain aspects, at least one of the product categories may represent a default category specified by system 140 and additionally or alternatively, by a financial institution or business entity associated with system 140. In other aspects, user 110 may, through device 104, access a configuration interface provided by system 140 (e.g., a web page or other graphical user interface (GUI)), and through the configuration interface, user 110 may establish at least one of the product categories, associate one or more types of purchased products or services with the established product categories, and additionally or alternatively, associate products or services purchased using particular financial instruments or accounts with the established product categories.

By way of example, user 110 may, through the configuration interface presented by device 104, establish a new product category named “Impulse Buys,” and further, may associate purchases of clothing, shoes, and accessories with the established “Impulse Buys” category. Additionally or alternatively, user 110 may use a particular credit card account (e.g., a Discover™ account held by user 110) for impulse purchasers at various retailers. In some instances, and through the configuration interface presented by device 104, user 110 may link any purchase transaction involving user 110's Discover™ account to the newly established “Impulse Buys” category.

In other instances, user 110 may access the configuration interface provided by system 140 (e.g., through device 104), and may link purchase transactions at a specific retailer with one or more of the product categories. For example, system 140 may establish a default “Gas Purchases” category that enables user 110 to track purchases of fuel on a monthly basis. Further, user 110 may be a member of a rewards program provided by a fuel distributor (e.g., ExxonMobil™), and in some instances, user 110 may link purchases of fuel from ExxonMobil™ retailers to the default “Gas Purchases” category (e.g., using the configuration interface presented by device 104) to track fuel purchases from ExxonMobil™ retailers.

Further, in some aspects, system 140 and/or user 110 may associate a default or user-established product category with purchases of products or goods from retailers disposed within virtual geographic boundaries (e.g., within user-specified or default geo-fences). For example, system 140 may establish a default “Lunch” category to enable user 110 to track monthly purchases of meals during a predetermined time period (e.g., a lunch hour between 11:30 a.m. and 1:00 p.m.). In certain aspects, user 110 may access the configuration interface provided by system 140 (e.g., through device 104) and may link the established “Lunch” category with a corresponding geo-fence to track purchases that fall within a predetermined radius of user 110's workplace (e.g., one-half mile). Further, the disclosed embodiments may also enable user 110 to establish or modify previously established temporal limitations on product categories. For example, system 140 may link the established “Lunches” category to purchases of food that fail within a default temporal range (e.g., 11:30 a.m. to 1:00 p.m.). User 110 may, however, generally eat late lunches that fall between 2:00 p.m. and 3:00 p.m., and through the configuration interface presented by device 104, user 110 may re-configured the default temporal range to accommodate user 110's lunch schedule.

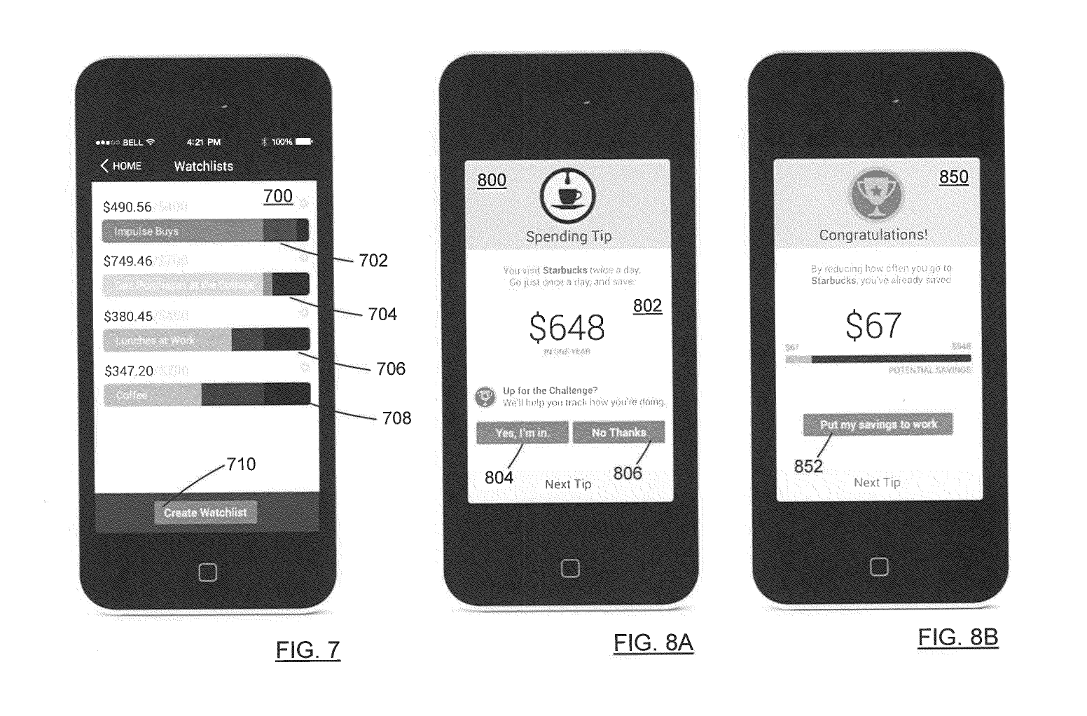

System 140 may be configured to receive and store product category data, geo-fences, and temporal ranges provided by user 110 within a corresponding data repository (e.g., database 144 and/or a cloud repository accessible over network 120). In some embodiments, system 140 may be configured to provide to device 104 data indicative of user 110's spending within the established product categories during a corresponding time period. Device 104 may, in certain aspects, receive the spending data, and render the spending data for presentation to user 110 within a corresponding interface, such as a portion of a web page or graphical user interface generated by an executed application, as described below in reference to FIG. 7.

FIG. 7 illustrates an exemplary interface 700 that tracks spending by user 110 in one or more product categories, consistent with the disclosed embodiments. In some aspects, interface 700 may be displayed by device 104 in response to spending data received from system 140.

As described above, the received spending data may identify accumulated spending by user 110 on purchases linked to one or more user-specified or default product categories within a predetermined period (e.g., a prior month, a prior year, etc.). By way of example, interface 700 may track accumulated spending on purchases linked to an “Impulse Buys” category 702, a “Gas Purchases” category 704, a “Lunches” category 706, and a “Coffee” category 708. The disclosed embodiments are not limited to these exemplary product categories, and other instances, interface 700 may include any additional or alternate number of system-defined default products categories and/or user-specified product categories.

Further, as illustrated in FIG. 7, interface 700 also presents to user 110 a yearly budget for each product category, current accumulated spending for each category, and further, a visual representation (e.g., a bar graph) indicating the relationship between the current accumulated spending and the established budget. For example, for “Coffee” category 708, user 110's current accumulated spending may be $347.20, and the yearly budget may be $700. In some aspects, the yearly budgets for each of the product categories may represent a default budget established by system 140 and/or the financial institution associated with system 140.

In other aspects, using an interface provided by system 140 and presented by device 104, system 140 may reconfigure one or more of the displayed product categories to modify the yearly budget. For example, user 110 may click, touch, or otherwise select a predetermined portion of purchase tracking interface 700 (e.g., “create watchlist” 710) to access the configuration interface and establish one or more product categories, associate purchases, geo-fences, and/or temporal ranges to the categories, and modify or establish spending targets and/or temporal units for the spending targets (e.g., monthly, yearly, etc.).

In the embodiments described above, system 140 may be configured to monitor and track spending by user 110 on purchases associated with predetermined or user-specified product categories, ranges of transaction times, and geographic boundaries. For example, as described above, system 140 may be configured to track not only user 110's total yearly spending on Starbucks™ coffee (e.g., category 708 of FIG. 7), but to also track a number of times that user 110 visits a local Starbucks™ each day, time period or periods during which user 110 visits the local Starbucks™, and a geographic position of the local Starbucks™. In certain aspects, system 140 may store the tracked spending information in a corresponding data repository (e.g., database 144 and/or a cloud-based data repository accessible to system 140 across network 120). Further, in certain embodiments, system 140 may access portions of the tracked spending information to provide user 110 with interactive financial games, incentives, and programs. In some instances, the provided interactive financial games, incentives, and programs highlight user 110's spending in one or more product categories, and provide, to user 110, opportunities to reduce spending in the one or more product categories and transfer surplus funds to one or more savings, checking, investment, retirement, credit card, line-of-credit, loan, or retirement accounts.

By way of example, system 140 may determine, based on a portion of the tracked spending information, that user 110 visits a local Starbucks™ twice per workday, and further, that by visiting the local Starbucks™ once per workday, user 110 would save 648 each year. In some aspects, system 140 may be configured to present, to user 110, an opportunity to “opt-in” to and participate in an interactive financial game that tracks not only user 110's spending during the single daily visit to the local Starbucks™, but also user 110's accumulated surplus funds due to user 110's forbearance of a second daily visit. In some embodiments, the user 110's interaction with the interactive financial game may highlight the actual costs associated with user 110's daily purchases and the lost opportunities for saving and investment related to these daily purchases. System 140 may, for example, transmit information associated with the interactive financial game to device 104, which device 104 may render for presentation to user 110, as described below in FIGS. 8A and 8B.

FIG. 8A illustrates an exemplary interface 800 that enables user 110 to opt-in to and participate in an interactive financial game provided by a financial institution, consistent with the disclosed embodiments. In some aspects, interface 800 may be displayed by device 104 in response to interactive financial game information and portions of tracked spending information provided by system 140, as described above.

In FIG. 8A, interface 800 may present to user 110 information identifying a history of user 110's purchase transactions at one or more retailers. For example, in portion 802, interface 800 may indicate that user 110 visits the local Starbucks' twice each day, and further, that user 110 would accrue savings of $648 in one year if user 110 were to visit the local Starbucks™ once each day. In some aspects, interface 800 may present the potential accrued savings by user 110 as a “spending tip” that may, for example, provide an insight-based “nudge” that motivates user 110 to change future spending habits.

Interface portion 802 may also provide a challenge to user 110 to change current spending habits (e.g., visit the local Starbucks™ once per day), and grant permission to the financial institution associated with system 140 to track user 110's spending, determine user 110's surplus accumulated funds (e.g., due to changed spending habits), and provide regular updates to device 104. Interface 800 may also include selectable regions 804 (e.g., “Yes, I'm in”) and 806 (e.g., “No Thanks”) that enable user 110 to opt-in to the challenge or opt-out of the challenge.

By way of example, user 110 may click on, touch, or otherwise select region 804 to participate in the interactive financial game, and device 104 may generate and transmit information indicating user 110's desire to participate in the interactive financial game to system 140. The transmitted information may, in certain aspects, confirm user 110's intention to participate and further, identify user 110 and the product category subject to spending tracking. Alternatively, if user 110 elects not to participate in the financial investing game, user 110 may click on, touch, or otherwise select region 804, and device 104 may generate and transmit to system 140 information indicative of user 110's decision.

Upon receipt of the information confirming user 110's decision to participate in the interactive financial game, system 140 may store the received information in a corresponding data repository (e.g., database 144 and/or a cloud-based data repository accessible to system 140 across network 120). Further, system may extract, from the received information, an identifier of user 110 (or an identifier of device 104) and an identifier of the product category subject to spending tracking. In certain aspects, system 140 may be configured to access customer, account, and transaction data associated with user 110 (e.g., customer data 144A, account data ‘144B, and/or transaction data 144C). Further, using any of the exemplary techniques described above, system 140 may be configured to monitor and track user 110's spending on purchases linked to product category, and to determine the surplus funds accumulated in one or more of user 110's accounts due to the changed spending habits resulting from user 110's participation in the interactive financial game.

Further, as described above, system 140 may be configured to generate update data that identifies the surplus funds accumulated during user 110's participation in the interactive financial game. In some aspects, system 140 may generate and transmit the update data to device 104 across network 120 at a regular temporal intervals, in response to user 110's spending on the identified product category, and additionally of alternatively, in response to a request received from device 104 (e.g., from an application executed by device 104 through a corresponding API).

By way of example, system 140 may be configured to transmit update data every fifteen minutes, every thirty minutes, every hour, or at any additional or alternate temporal interval appropriate to system 140 and/or device 104. In other instances, user 110 may access a configuration interface provided by system 140 (e.g., using device 104), and may specify the temporal interval at which system 140 transmits update data to device 104. Further, in other instances, system 140 may be configured to transmit update data to device 104 in response to a predetermined or user-specified spending on goods and services associated with the identified product category. In certain aspects, device 104 may be configured to receive the transmitted update data, and render the received update data for presentation to user 110 in a corresponding update interface, as described in FIG. 8B.

FIG. 8B illustrates an exemplary update interface 850 that presents updates on surplus funds accumulated by user 110 during participation in an interactive financial game, consistent with the disclosed embodiments. In some aspects, interface 850 may be displayed by device 104 in response to update data provided by system 140, as described above.

As illustrated in FIG. 8B, update interface 850 may present to user 110 a current amount of surplus funds accumulated during user 110's due to the changed spending habits, a projected yearly savings resulting from user 110's participation in the interactive financial game, and further, a visual representation (e.g., a bar graph) indicating the relationship of the actual amount of accumulated surplus funds and the total projected savings. For example, interface 850 may indicate that, by participating in the interactive financial game and visiting the local Starbucks™ once daily, user 110 has saved $67 that would otherwise have been used to purchase coffee. Further, interface 850 may also indicate that system 140 projects a total savings of $648 resulting from user 110's participation in the interactive financial game over the course of a year, and may further include text and graphics that reinforce the changes in user 110's spending habits through positive reinforcement.

Update interface 850 may also include a selectable region 852 (e.g., “Put My Savings To Work”) that enables user 110 to request additional information on electronic funds transfers and other financial services offered by the financial institution associated with system 140. By way of example, user 110 may click on, touch, or otherwise select region 852 to request information from system 140 identifying financial services offered by the financial institution, and device 104 may be configured to transmit the request, which may include an identifier of user 110 and/or device 104, to system 140 across network 120 using any of the communications protocols outlined above.

System 140 may receive the request for financial services information from device 104, and may determine that the received request corresponds to a contextual event that may trigger an EFT transaction between accounts held by user 110 (e.g., in step 402 of FIG. 4). Using any of the exemplary techniques described above, system 140 may automatically identify values of one or more parameters that facilitate the potential EFT transaction (e.g., a source account, a destination account, and/or a transfer amount). For example, the system 140 may determine that user 110 purchases coffee at the local Starbucks™ using a debit card linked to user 110's checking account, and further, that user 110 participates in the interactive financial game outlined above to reduce spending at the local Starbucks™. System 140 may, in some instances, also identify the amount of surplus funds accumulated by user 110 during participation in the interactive financial game.

In an embodiment, system 140 may identify user 110's checking account as the source account for the potential EFT transaction, may establish a portion of the surplus funds as the transfer amount for the potential EFT transaction, and further, may identify an additional account held by user 110 (or others) as the destination account based on, for example, one or more prior online sessions involving user 110 (e.g., in steps 408 and 410 of FIG. 4). In other instances, and as described above, system 140 may be configured to select the source account, the destination account, and/or the transfer amount based on, among other things, one or more rules specified by user 110 and the financial institution, business logic associated with the financial institution, data indicative of balances of accounts held by user 110 (e.g., account data 144B), and a history of prior transactions based on stored transaction data (e.g., transaction data 1440) and/or monitored activity of user 110 in prior online sessions.

System 140 may, in some aspects, transmit the identified parameter values to device 104 across network 120 (e.g., in step 412 of FIG. 4). In response to the received parameter values, device 140 may be configured to present to user 110 an EFT transaction interface (e.g., interface 640 of FIG. 6B) having fields prefilled with portions of the received parameter values. Using the techniques described above, user 110 may click, touch, or otherwise select a predetermined portion of the EFT transaction interface (e.g., authorization portion 680 of FIG. 6) to confirm the prefilled parameter values (or to confirm user-specified modifications), and upon receipt of the confirmation (e.g., in step 414 of FIG. 4), system 140 may be configured to execute the corresponding EFT transaction in accordance with the confirmed parameter values (e.g., in step 418 of FIG. 4).

As outlined above, system 140 may provide a notification of the completed

EFT transaction to device 104, which may process and render the provided notification for presentation to user 110 (e.g., in step 420 of FIG. 4). In certain aspects, the presented notification may confirm the execution of the EFT transaction in accordance with the transfer parameter values, as noted above.

Although the above exemplary embodiments describe transaction parameters including a source, destination, and amount, the system 140 may be configured to receive, identify, and provide any type of parameters or terms associated with a transfer transaction. Other transaction parameters that may be employed include, but are not limited to, time and date of the transaction, multiple sources, destinations, or amounts, recurring or divided transactions, intermediate sources or destinations, geographical identifiers, sensor-based data, transaction sequences or history, data identifying the lowest cost method to complete the transaction, interest rates, taxes, and encrypted or coded data.

Other embodiments will be apparent to those skilled in the art from consideration of the specification and practice of the embodiments disclosed herein. It is intended that the specification and examples be considered as exemplary only, with a true scope and spirit of the disclosed embodiments being indicated by the following claims.

What is claimed is:

1. A system, comprising:
a memory storing instructions; and
one or more processors configured to execute the instructions to perform operations including:
identify a contextual event that triggers an account transfer transaction, the identification being based on contextual data associated with a first user;
identifying (i) a first account of the first user based on the contextual triggering event and (ii) a second account of the first user based on the contextual triggering event and a set of rules associated with the first user;
obtaining online session data associated with the first user, the online session data corresponding to at least one prior online session of the first user, the online session data comprising account information associated with at least one of the first or second accounts;
determining a first amount of funds to transfer from the first account to the second account based on at least a portion of the online session data;
generating, based on the triggering event and the set of rules, first information for presentation to the first user in an interface, the first information including prefilled content identifying at least one of the first account as a first source account in the interface, the second account as a destination account in the interface, or the first transfer amount in an amount field of the interface; and
generating, in response to an authorization, second information for presentation to the first user, the second information including a notification of an occurrence of a transfer of funds from the first account to the second account.

2. The system of claim 1, wherein the one or more processors are further configured to perform the operations of identifying the contextual triggering event without input from the first user.

3. The system of claim 1, wherein the contextual data identifies at least one of a geographic position of a device associated with the first user, first temporal data associated with the at least one geographic position, at least one purchase transaction involving one of the accounts held by the first user, or second temporal data associated with the at least one purchase transaction

4. The system of claim 1, wherein the contextual triggering event corresponds to an expected occurrence of a purchase transaction involving a retailer, the expected purchase transaction being associated with a transaction amount and involving the second account of the first user.

5. The system of claim 4, wherein the first transfer amount comprises at least a portion of the transaction amount of the expected purchase transaction.

6. The system of claim 4, wherein the one or more processors are further configured to perform the operations of:
identifying, based on the contextual data, a plurality of prior purchase transactions that involve the first user and the retailer, the prior purchase transactions being associated with prior transaction amounts and prior transaction times;
identifying geographic positions associated with the prior purchase transactions;
establishing a geographic boundary that surrounds the identified geographic positions; and
establishing a temporal range representative of prior transaction times.

7. The system of claim 6, wherein the one or more processors are further configured to perform the operations of:
receiving positional information identifying a current geographic position of the first user, the received positional information being associated with a current time;
determining whether (i) the current geographic position is disposed within the established geographic boundary and (ii) the current time falls within the established temporal range; and
when it is determined that the current geographic position falls within the established geographic boundary and that the current time falls within the temporal range, establishing the expected occurrence of the purchase transaction involving the retailer.

8. The system of claim 7, wherein the one or more processors are further configured to perform the operations of establishing at least one of the prior transaction amounts as the transaction amount associated with the expected purchase transaction.

9. The system of claim 1, wherein the one or more processors are further configured to perform the operations of:
generating information identifying (i) at least one category of products purchased by the first user during a corresponding time period, and (ii) an amount of funds spent to purchase the at least one category of products; and
providing the generated information to a device for presentation to the first user.

10. The system of claim 9, wherein the one or more processors are further configured to perform the operations of:
obtaining information identifying a change in a spending habit of the first user;
determining, for the corresponding time period, an amount of surplus funds accumulated in the first account due to the change in the spending habit; and
providing information identifying the amount of surplus funds to a device for presentation to the first user.

11. The system of claim 1, wherein the one or more processors are further configured to perform the operations of:
transmitting the first information to a first device associated with the first user; and
transmitting the second information to at least one of the first device or a second device associated with the first user.

12. The system of claim 1, wherein the one or more processors are further configured to perform the operations of:
determining a third account based on the triggering event and the set of rules; and
generating, based on the triggering event and the set of rules, the first information such that the prefilled content identifies the third account as a second source account and the amount field of the interface includes:
a first amount field associated with the first account corresponding to a transfer of the first transfer amount of funds from the first account to the second account, and
a second amount field associated with the third account corresponding to a second transfer amount reflecting a second amount of funds to transfer from the third account to the second account.

13. The system of claim 1, wherein:
the one or more processors are further configured to determine the first transfer amount based on at least one of:
a transaction history associated with a set of accounts associated with the first user;
a determined expense history associated with the set of accounts;
a user-defined transfer amount;
an account balance of the second account;
an account balance of the first account;
an account balance of a third account associated with the first user;
a payment parameter associated with the second account;
a fourth account associated with a second user;
a minimum payment due on at least one of the first or second accounts; or
a rule based on at least one parameter associated with the first account or at least one parameter associated with the second account; and
wherein the one or more processors are further configured to identify at least one of the first or second accounts based on at least one of:
a transaction history associated with a set of accounts associated with the first user;
a determined expense history associated with the set of accounts;
a user-defined transfer amount;
an account balance of the second account;
an account balance of the first account;
an account balance of a third account associated with the first user;
a payment parameter associated with the second account,
a fourth account associated with a second user;
a minimum payment due on at least one of the first or second accounts; or
a rule based on at least one parameter associated with the first account or at least one parameter associated with the second account.

14. The system of claim 1, wherein the one or more processors are further configured to perform operations including:
obtaining, from the online session data, an identifier of the first account and an identifier of the second account;
determining a type of the first account and a type of the second account based on corresponding ones of the obtained identifiers; and
determining the first transfer amount based on at least one of the determined type of the first account or the determined type of the second account.

15. The system of claim 1, wherein:
the first account is one of a checking account, a savings account, a debit account, a credit card account, a line-of-credit account, or a loan account; and
the second account is one of a checking account, a savings account, a debit account, a credit card account, a line-of-credit account, a loan account, a bill account associated with services provided to the user by a service provider, or a bill account associated with a product purchased by the user.

16. The system of claim 1, wherein:
the authorization is one of an authorization received from the first user to perform the transfer of funds from the first account to the second account, or an authorization automatically generated by the one or more processors based on the set of rules; and
the notification comprises at least one of a visual notification, a tactile notification, or an audible notification.

17. A computer-implemented method, comprising:
identifying, by at least one processor, a contextual event that triggers an account transfer transaction, the identification being based on contextual data associated with a first user;
by the at least one processor, identifying (i) a first account of a first user based on the contextual triggering event and (ii) a second account of the first user based on the contextual triggering event and a set of rules associated with the first user;
obtaining, by the at least one processor, online session data associated with the first user, the online session data corresponding to at least one prior online session of the first user, the online session data comprising account information associated with at least one of the first or second accounts;
determining, by the at least one processor, a first amount of funds to transfer from the first account to the second account based on at least a portion of the online session data;
generating, by the at least one processor, and based on the triggering event and the set of rules, first information for presentation to the first user in an interface, the first information including prefilled content identifying at least one of the first account as a first source account in the interface, the second account as a destination account in the interface, or the first transfer amount in an amount field of the interface; and
in response to an authorization, generating, by the at least one processor, second information for presentation to the first user, the second information including a notification of an occurrence of a transfer of funds from the first account to the second account.

18. The method of claim 17, further comprising identifying the contextual triggering event without input from the first user.

19. The method of claim 17, wherein the contextual data identifies at least one of a geographic position of a device associated with the first user, first temporal data associated with the at least one geographic position, at least one purchase transaction involving one of the accounts held by the first user, or second temporal data associated with the at least one purchase transaction.

20. The method of claim 17, wherein the contextual triggering event corresponds to an expected occurrence of a purchase transaction involving a retailer, the expected purchase transaction being associated with a transaction amount and involving the second account of the first user.

21. The method of claim 20, wherein the first transfer amount comprises at least a portion of the transaction amount of the expected purchase transaction.

22. The method of claim 20, further comprising:
identifying, based on the contextual data, a plurality of prior purchase transactions that involve the first user and the retailer, the prior purchase transactions being associated with prior transaction amounts and prior transaction times;
identifying geographic positions associated with the prior purchase transactions;
establishing a geographic boundary that surrounds the identified geographic positions; and
establishing a temporal range representative of prior transaction times.

23. The method of claim 22, wherein the one or more processors are further configured to perform the operations of:
receive positional information identifying a current geographic position of the first user, the received positional information being associated with a current time;
determine whether (I) the current geographic position is disposed within the established geographic boundary and (ii) the current time falls within the established temporal range; and
when it is determined that the current geographic position falls within the established geographic boundary and that the current time falls within the temporal range, establishing the expected occurrence of the purchase transaction involving the retailer.

24. The method of claim 23, wherein the one or more processors are further configured to perform the operations of establishing at least one of the prior transaction amounts as the transaction amount associated with the purchase transaction.

25. The method of claim 17, wherein the one or more processors are further configured to perform the operations of:
generating information identifying (i) at least one category of products purchased by the first user during a corresponding time period, and (ii) an amount of funds spent to purchase the at least one category of products; and
providing the generated information to a device for presentation to the first user.

26. The method of claim 25, wherein the one or more processors are further configured to perform the operations of:
obtaining information identifying a change in a spending habit of the first user;
determining, for the corresponding time period, an amount of surplus funds accumulated in the first account due to the change in the spending habit; and
providing information identifying the amount of surplus funds to a device for presentation to the first user.

27. A tangible, non-transitory computer-readable medium storing instructions that, when executed by at least one processor, cause the at least one processor to perform a method, comprising:
identifying a contextual event that triggers an account transfer transaction, the identification being based on contextual data associated with a first user,
identifying (i) a first account of a first user based on the contextual triggering event and (ii) a second account of the first user based on the contextual triggering event and a set of rules associated with the first user;
obtaining online session data associated with the first user, the online session data corresponding to at least one prior online session of the first user, the online session data comprising account information associated with at least one of the first or second accounts;
determining a first amount of funds to transfer from the first account to the second account based on at least a portion of the online session data;
generating, based on the triggering event and the set of rules, first information for presentation to the first user in an interface, the first information including prefilled content identifying at least one of the first account as a first source account in the interface, the second account as a destination account in the interface, or the first transfer amount in an amount field of the interface; and
generating, in response to an authorization, second information for presentation to the first user, the second information including a notification of an occurrence of a transfer of funds from the first account to the second account.
